(19) United States
(12) Patent Application Publication
(10) Pub. No.: US 2011/0153213 A1
(43) Pub. Date: Jun. 23, 2011

(54) Method to evaluate plants and soils to optimize conditions for phytoremediation

(76) Inventor: Catherine Lynn Buchanan, Toledo, OH (US)

(21) Appl. No.: 12/586,861

(22) Filed: Sep. 29, 2009

Related U.S. Application Data
(60) Provisional application No. 61/136,717, filed on Sep. 29, 2008.

(51) Int. Cl. G06F 19/00; G06F 17/10

(52) U.S. Cl. 702/2; 703/2

(57) ABSTRACT

Phytoremediation is an economical method to remove contaminants from soils. Understanding the mechanisms that control adsorption of a contaminant to a soil particle is the first step in designing a phytoremediation project in order to optimize removal of said contaminant. To characterize soil conditions, the following data were collected: a) historical land use information, b) evaluating on-site soils and plants for contaminant identity and concentrations, c) particle size analysis of soil samples, d) estimate total organic matter of soil samples, e) conducting batch adsorption experiments to determine Kd values, varying pH levels and concentrations of standard solutions, g) testing on-site pH of soils, h) testing pH levels of standard solutions prior to and after contact with soils used for batch adsorption experiments, i) conducting alkalinity/hardness tests. Once the conditions are known, experiments can be designed manipulating conditions to find optimal conditions to maximize the removal of a contaminant.

### BACKGROUND OF THE INVENTION

The field of this invention is the area of environmental engineering of application in the removal of contaminants in soils, comprising of a method of comprehensive data collection and evaluation to understand the mechanisms that control adsorption and plant growth, which will then enable the manipulation of soil conditions in order to optimize soil conditions to increase the plant uptake of contaminants. The data gained is from a series of soil and plant analyses comprising: a) historical land use information, b) evaluating soils for target contaminant and concentrations, c) evaluating on-site plants for target contaminant and concentrations, d) particle size analysis of soil samples, e) total organic matter of soil samples, f) conducting batch adsorption experiments to determine Kd values at varying pH levels and varying concentrations of standard solutions, g) conducting on-site pH testing of soils, h) testing pH levels of standard solutions prior to and after contact with soils used for batch adsorption experiments, i) conducting alkalinity/hardness tests.

The contaminated sites that were chosen to demonstrate this method are located in the State of Ohio in the United States (FIG. 1). Two of the sites, Treasure Island and Bassett Street, are located in Toledo, Ohio and the third site is located in Tiffin, Ohio. The Emmajean soil, the fourth site and also located in Toledo, was analyzed as a reference, because its soils (Del Rey loam series) are found throughout the state and the site lacks a direct source of contamination. The Emmajean site makes for a good comparison for soil conditions pertaining to plant growth and adsorptive capacity of the soils and could possibly be used as a soil amendment in contaminated areas where plant growth is inhibited. The heavy metal chosen for this study is copper because, as stated previously, Ohio is second among all 50 states in the release of copper to the environment. Although copper functions as an essential nutrient to plants and animals, it has a Threshold Effect Level (TEL) of only 36 mg/kg (MacDonald et al., 2000), nearly identical to that of lead. The TEL represents the concentration below which adverse effects are expected to occur only rarely. The Probable Effect Level (PEL), the concentration above which adverse effects are expected to occur frequently, has been reported at 197 mg/kg for copper (ibid.). Within this context, adverse are defined as those associated with toxicity for benthic invertebrates such as the amphipod Hyalella azteca and the midge Chironomus riparius (cf. Ingersoll et al., 1996).

Globally, there are many locations that have been extensively contaminated by human actions. These sites are a danger to human health and ecosystem integrity. They are often found in economically struggling countries that cannot afford to allocate funds to conduct massive clean up using conventional methods. Conventional methods for remediation of contaminated soils include acid leaching, excavation and storage, physical separation of the pollutants, and electrochemical processes (Brooks, 1998). Some on-site treatments are dilution of the contaminated soil with clean topsoil, or immobilization of the contaminants by use of complexing agents or increasing the soil pH by liming (Khan et al., 2000). Some of the remediation methods listed do not address the removal of the contaminant from the soil, but merely shift the contaminant from one location to another, requiring further treatment for the actual removal of the contaminant. Nor do conventional methods address the issue of creating more hazardous materials as by-products of the removal process, which have to be disposed of as hazardous waste (Dijkstra et al., 2004). Other problems associated with these treatments are the potential to compromise the soil's physical structure, the reduction of microbial activity within the soil, and the destruction of a favorable environment for plant growth, resulting in barren land (Khan et al., 2000).

An economical alternative to conventional methods is phytoremediation, the use of plants to physically remove contaminants from the soil. Phytoremediation is a rapidly growing technology that is being studied on a worldwide basis due to its economical and non-destructive nature (Khan et al., 2000). With respect to heavy metal contamination, phytoremediation is also being studied for its potential to become a major mining industry known as phytoextraction/phytomining (Brooks et al., 1998).

### SUMMARY OF THE INVENTION

The advantages of utilizing plants for remediation of contaminated soils are becoming recognized. For a community wishing to save financial resources, phytoremediation is less costly than conventional methods due to its low installation and maintenance costs (Rock, 1996). Phytoremediation may also establish wildlife habitat and can add to the aesthetics and recreational benefits of the community (Rock, 1996). Additional advantages of phytoremediation are that 1) plants can stabilize and/or remove contaminants, 2) contaminants can be transferred to a treatment or disposal site with relative ease, and 3) diversity and productivity of the soil ecosystem may be maintained (Khan et al., 2005). Potential drawbacks of phytoremediation could be 1) the creation of an attractive nuisance (animals grazing on the plants), 2) the removal of the contaminant could take decades, and 3) the disposal of the harvested plant material. However, with the onset of phytomining, plant material can be crushed and/or ashed and stored until the technology of phytomining allows for efficient recovery of the contaminant if the contaminant is desired as reusable, such as a heavy metal.

The success of phytoremediation for removal of contaminants is dependent upon several physiological characteristics of the plant. These characteristics include the ability to 1) hyperaccumulate the contaminant within its tissues, 2) produce high biomass, 3) adapt to metalliferous soils, 4) propagate easily, 5) survive varying climatic conditions (Deram et al., 2000) and 6) the depth of the root system because removal of the contaminant is accomplished in the root zone. An ideal root zone would be relatively deep, approximately 0.5 to 1 meter, and very fibrous, with strands extending in every direction, achieving a greater root surface area available for removal of the contaminant. Efficient removal of the contaminant is possible through the continuous growth and harvest of high biomass producing hyperaccumulator species (Raskin et al., 1997). Some plants naturally uptake high concentrations of specific contaminants, while other plants can be induced to increase their uptake through the use of chelating agents such as EDTA (Brooks et al., 1998).

Although phytoremediation has been used for the removal of various contaminants, such as heavy metals, other studies have been conducted to expand the field of phytoremediation. Some of these studies include manipulating genes to increase plant uptake (Rugh et al., 1996), remediation of organic compounds through breakdown of toxic chemicals into non-toxic compounds by Lemna gibba (Ensley et al., 1997) and Cannabis sativa (Campbell et al., 2002), understanding the relationship between specific functional genotypes and the changes in microbial communities due to contamination of petrochemicals (Siciliano et al., 2003), studying the relationship between the microbial community and the plant for the detoxification of contaminants (Hannink et al., 2001), assessing the health of fungal communities in root systems of Solidago gigantean in contaminated soils (Vallino et al., 2006), using aquatic plants for the removal of heavy metals (Salt et al., 1995) and small-scale oil spills in marsh environments (Dowty et al., 2001), and adding chelating agents (EDTA) to the soil to increase bioavailability of heavy metals (Jiang and Yang, 2004).

The common focus of these studies is how to enhance the remediation process of the plant for a target contaminant. However, a few questions come to mind that need to be asked before a project is implemented. For a community that is economically challenged, what is the feasibility of implementing these methods when funding is severely limited? What is the possibility of creating invasive species using gene manipulation? When using chelating agents, will the chelating agent also remove the nutrients from the soil? Is the chelating agent an environmental contaminant, such as EDTA? Is there the possibility of creating an attractive nuisance when using plants for soil or water remediation? Although these questions are not directly related to the study, they are pertinent in how to approach the clean up of a site. Working within the resources that are available to the community is the basis for analyzing the components that naturally control soil adsorption to see if the natural conditions can be optimized for removal of a contaminant.

A plant's ability to uptake contaminants is directly related to the bioavailability of the contaminant such as a heavy metal (Rieuwerts et al., 1998), which is influenced by the adsorptive capacity of the soil (Selim and Iskandar, 1999). The adsorptive capacity determines how well the substrate is able to adsorb heavy metal ions and is influenced by the organic matter content, the type and quantity of various clay minerals, adsorption properties, cation exchange capacity, soil pH, alkalinity and hardness (Raikhy and Takkar, 1981). Although the following information is publicly available, it is provided as a review for their roles in contaminant uptake.

Organic Matter

The origin and composition of the organic matter have a direct impact on the adsorptive capacity of the soil (Lair et al., 2006). Organic matter typically increases the complexation capacity of the soil, which is “The maximum quantity of a given metal that can be bound per gram of substance” (Selim and Iskandar, 1999). Much of the organic matter found in soils consists of humic acids (HA), which are long carbon chain compounds, with high molecular weight, brown to black in color and composed of decayed plant material. Humic acids are soluble in alkali but insoluble in acid and contain many charged sites where adsorption can occur (Weber, 2000). The HA molecule is naturally oxidized, giving specific sites a negative charge, which results in excellent metal complexation and influences the magnitude at which cations are able to adsorb (Casagrande et al., 2004).

Organic matter can affect adsorption in two ways that are opposite from each other. First, the heavy metal ion may form a complex with the soluble fraction of the humic substance. When a decrease in pH occurs, the soluble humic substance becomes mobile and serves as a transport mechanism to the heavy metal. Second, the heavy metal ion may form a complex with the solid portion of the humic substance. When an increase in pH occurs, the heavy metal ion stays bonded to the solid particle and is immobilized in the soil (Selim and Iskandar, 1999).

In a previous study, humic acids were found to enhance heavy metal adsorption (in particular copper) to mineral surfaces due to the number of available sites located on the chain, and to assist in the formation of ionic bonds resulting in binding tightly the heavy metal ion to the mineral surface (Arias et al., 2002). With the addition of HA, the results of this study suggested that the copper has the ability to form chelates and the ease of their formation increased with increasing concentration of HA.

Adding dissolved organic carbon (DOC) to the soil resulted in an increase in copper desorption in both acidic and alkaline soils, with the acidic soils desorbing more than the alkaline soils (Mesquita et al., 2004). At lower pH values, copper adsorption is insignificant due to the competition of the H+ ion. At pH values greater than 9, copper adsorption decreases because of the formation of dissolved organic-metal complexes, metal carbonate and hydroxide complexes (Grassi et al., 2000). In a study conducted using the liquid fraction of animal manure and copper, there was a significant relationship between the solubility of the copper and the DOC concentration in solution (Selim and Iskandar, 1999). In addition to pH being a primary factor in the mobility of heavy metals, metal complexation with high molecular weight organic matter was the main component in increasing the solubility of the heavy metal (Selim and Iskandar, 1999). Increasing the solubility of a heavy metal ion, gives the plants a greater chance at being able to remove the heavy metal from the soil. However, increased solubility of the heavy metal does not necessarily mean the heavy metal is bio-available. The heavy metal ion and/or the organic molecule could be too large for the plant to uptake. The heavy metal ion might not be within the root zone of the plant. A migration study of lead and copper found the metals to be in lower concentrations in plants where surface deposition had occurred, but double in concentrations in plants where the copper and lead had migrated into the root zone along geological fault lines (Farago et al., 1992). Furthermore, the permeability of the soil may be too high resulting in leaching of the heavy metal right past the root zone of the plants.

Overall, organic matter and heavy metal interactions produce three interrelated groups of species that influence the outcome of bioavailability to plants (Selim and Iskandar, 1999). First, the solid portion of organic material serves as a substrate that has the ability to tightly bind heavy metal ions. The tightly bound ions are removed from the water column and become sequestered in the sediments, decreasing the bioavailability to plants (Selim and Iskandar, 1999). Second, dissolved organic matter can bind to heavy metals and form soluble heavy metal complexes that can be transported by groundwater, potentially becoming bioavailable to plants (Selim and Iskandar, 1999). And, third, the most bio-available heavy metal ions are the free or weakly bonded ions (outer-sphere complexes) that are easily transported to the plant by water (Bradl, 2004).

Clay Minerals

The clay mineral content of the soil influences the adsorption of heavy metals due to the properties of ionic and/or covalent bonds (Gong and Donahoe, 1997). For example, sandy soils do not have a high affinity for adsorbence of heavy metals due to the inert properties of sand (Zhang et al., 2006). Clay minerals are primarily fine-grained inorganic, crystalline materials that are responsible for some of the cation exchange in soils (Hausenbuiller, 1978) and may lead to the adsorption of copper ions to the clay particles. The finer particles in the soil have a larger surface area per unit weight, upon which positive and negative charges attract charged ions and water. The internal surfaces of fine clay particles increase the active surface area tremendously, particularly in the montmorillonite and hydrous mica clays, yet it remains unknown as to how great of an increase the internal surfaces contribute to the overall surface area (Allrichs, 1972). The finer clay particle is where a greater rate of adsorption takes place due to the availability of increased molar free energy. The particle, striving for a state of equilibrium to reduce the free energy, adsorbs more ions per unit area onto their surfaces (Zhang et al., 1999).

The internal interface of each clay particle is comprised of sheetlike molecules, or units, that may be held loosely together. As conditions change, the units may become disassociated from each other, and when brought closely together again, re-associated (Burden and Sims, 1999), which impacts the ability of the clay to adsorb ions. If the units are too close together, water has a difficult time passing through the interface thereby limiting contact of the heavy metal ion to the interface. If the units are too far apart, the water will carry them right through the interfaces, also limiting contact of the heavy metal to the interface (Burden and Sims, 1999).

The structure of the clay particles also has an impact on the adsorptive capacity of the soil. For example, the clinoptilolite zeolite exists in sheet-like structures, connected by few bonds, are relatively widely separated, containing open rings of alternating eight and ten sides. The formation of the sheets form channels throughout the crystal structure that allows for the passing of ions, acting as a chemical sieve, allowing the passage of some and blocking the passage of others (Amethyst Galleries, 1999; Bekta [symbol] and Kara, 2003). A clay mineral that has a favorable structure for adsorption is sepiolite. Sepiolite occurs in fibrous chain-structures that vary in length, but generally less than 5 mm in commercial samples. The channel like structure of sepiolite provides freedom of movement of water within the structure, creating favorable conditions for ion exchange between the sepiolite and heavy metal contaminated water (Bekta [symbol] et al., 2004). Although clinoptilolite and sepiolite are not found in Ohio, this serves as an example of understanding the role of clays in a phytoremediation project.

To achieve ideal conditions for phytoremediation, adsorption is needed to hold onto the ion loosely enough for plant ion uptake and to prevent migration of the ion to the groundwater. Therefore, the presence of a clay with a great adsorbing capacity is not a desirable characteristic for phytoremediation.

The analyses for clay/mineral content may become extremely expensive when dealing with heterogeneous soils. This expense is related to how many soil samples are needed to accurately characterize the location and type of mineral soils. To do a rough estimate for the presence of clay minerals, a particle size analysis can be conducted because clays are also classified according to particle size with the clay fraction consisting of no greater than 5 microns (μm) in diameter in accordance with ASTM standards. This analysis for particle size is inexpensive.

Adsorption

Adsorption of the copper ion uses the ionic properties of soil particles to create a covalent bond, an ionic bond, or chelation between the soil particle and the copper ion. The soil components that have demonstrated favorable adsorptive behaviors are silicate clay minerals and the humic acid (HA) fraction of organic matter (Weber, 2000). Therefore, the fraction of clay and the fraction of HA of the total soil sample are important to discern adsorption characteristics within the study soils.

The possibility of chemical reactions occurring that may interfere with phytoremediation must also be considered when planning remediation activities. Compounds (including organic matter) present in solution may compete with the copper ion for adsorption sites on the soil particles (Selim and Iskandar, 1999; Van Der Zee et al., 2004). Cations with a higher affinity than copper will out-compete the copper ion for a surface charge site (Hausenbuiller, 1978). Anions may form precipitates with the copper ion reducing the bioavailability of the copper ion for uptake by the plant (Hausenbuiller, 1978), which is contrary to the desired goal for phytoremediation. Organic matter has the ability to form tight ionic bonds with the copper ion and the soil particle. However, if soil conditions change, the organic matter may be released from the soil particle, taking with it the copper ion (Selim and Iskandar, 1999). As such, the solubility of the copper ion may be increased, possibly enhancing the bioavailability of that ion to the plants.

The adsorption mechanisms responsible for the copper ion going from a solution to a solid phase consist of three processes; adsorption, surface precipitation and fixation (Apak, 2002). The adsorption of heavy metals is considered a two-dimensional process at the solid/water interface (Sposito, 1984) and is often characterized as either specific adsorption or non-specific adsorption (McBride, 1994). Specific adsorption forms inner-sphere complexes between the heavy metal ion, the soil particle and/or organic matter. It results in a strong, irreversible binding (Reed and Cline, 1994). Non-specific adsorption is accomplished through cation exchange, forming weak outer-sphere complexes, using the electrostatic charge on the surfaces of the metals and the soil particles (McBride, 1994). Outer-sphere complexation is a reversible reaction that occurs fairly rapidly due to the electrostatic nature of the bond (Reed and Cline, 1994).

Surface precipitation is considered to be a three-dimensional “growth phenomenon” that occurs on the surface of the soil particles usually in saturated or supersaturated conditions (Selim and Iskandar, 1999). The factors controlling surface precipitation are the pH and relative concentrations of the cations and anions present (Reed and Matsumoto, 1993). Surface precipitation is commonly classified in one of three methods: 1) the formation of polymeric metal complexes; 2) a coprecipitate that is formed through a reaction with the ions from the sorbent; or 3) a homogeneous precipitate formed through the reactions of the ions within the solution, or their hydrolysis products (Selim and Iskandar, 1999).

Fixation is also three dimensional in nature and occurs by diffusion of an aqueous metal solution into the lattice network (pore spaces) of the clay minerals forming a solid particle (Sposito, 1986). Diffusion occurs when the system benefits at being in the lowest energy state possible (equilibrium) (Selim and Iskandar, 1999).

Due to the influence pH has on the mobility of the ions (Janssen et al., 1997), optimal pH level needs to be maintained in order to achieve optimal adsorption of the copper ion (Atanassova and Okazaki, 1997; Zhang et al., 2006). As stated previously, the soil components that demonstrate favorable conditions for adsorption are the clay minerals and the HA. However, the characteristic that is common to both clay minerals and HA that creates favorable conditions for adsorption is the same characteristic that has the ability to influence the pH. This characteristic is the large charged surface area. The charged surface area has the ability to pull cations and anions away from the hydrogen atom, or vice versa, affecting the pH of the soil (Hausenbuiller, 1978).

In order to compare the adsorptive capacity of the soils, a bioconcentration factor (BCF) may be used. The BCF is the ratio of the copper concentration in the plant and the copper concentration in the surrounding soil. The higher the ratio, the greater the potential of the plant to remove copper from the soil. This method can be useful when analyzing the copper concentrations of the same species of plant located at multiple sites.

Cation Exchange Capacity

Cation exchange capacity (CEC) is a measured value depicting the soil's capacity to adsorb cations. It is determined by the amount of clay and/or humus present in the soil (Anderson et al., 1982). The value of the CEC also determines the rate at which water is transported between the clay particles (Brady and Weil, 1999). The greater the CEC, the greater the soil's potential to exchange cations, which is reflective of the soil's ability to buffer acidic impulses (Burden and Sims, 1999). The buffer capacity is a calculated proportion of acids to bases, known as the percent base saturation, directly influencing the pH, alkalinity and hardness in the soils (Burden and Sims, 1999).

A soil characteristic that influences the CEC is particle size. The smaller the particle, the greater the surface area, increasing the amount of free energy available to bond ions. The large surface area results in nearly a zero surface strain between the ions and the soil particle (Zhang et al., 1999). Clays are also classified according to particle size. Therefore, the CEC of a known soil type can be estimated based on the percentages of clay and organic matter present. The CEC ranges from 49 me/100 g to as little as 2 me/100 g. The higher CEC is usually associated with high fractions of expanding clay and organic matter. The lower CEC is usually associated with sandy soils and very little organic matter (Hausenbuiler, 1978).

When analyzing the soil that has been targeted for remediation activities, the CEC characteristic of the soil may change with depth due to the migration of organic matter and/or fine clay minerals or a change in the soil strata (Wilcke, 2000). Change in soil strata, for example, could occur on a site that is composed of fill material.

Soil pH

In a majority of adsorption studies, the primary controlling factor for adsorption of heavy metals is pH (Zhang et al., 2006). In studies where the pH was decreased, there was an increase in copper and zinc concentrations in the column leachate (Gong and Donahoe, 1997; Zhang et al., 2006). In studies using alkaline soils, soils had a higher adsorption rate of copper compared to that of the non-alkaline soils (Raikhy and Takkar, 1981; Choudhury and Khanif, 2000).

Soil pH has a great effect on the plant's ability to uptake heavy metal ions (Bradl, 2004). If the results of a site investigation indicate that a soil amendment is needed to encourage plant growth, or to mobilize the target contaminant, the pH of the amendment must also be determined. This would avoid overloading the soil system resulting in the loss of its buffering capacity (Paschke et al., 1999). When using phytoremediation, the heavy metal should be mobile enough for the plant to uptake but not too mobile so that the metal migrates past the root system of the plant. The ion must also not be so insoluble that uptake cannot take place. Otherwise it will accumulate within the soil profile.

The role of organic matter in soil acidification is not well understood. Studies have yielded various results, demonstrating different mechanisms that cause a decrease in pH. One mechanism is the accumulation of organic matter (Williams, 1980). The humic acid chains in organic have the capability to affect soil pH through the exchange of cations and anions from the many charged sites on these chains. The ion exchange activity influences the formation of base ions and acid cations (McCauley et al., 2003). A second mechanism is the natural occurrence of the nitrogen cycle within the soil profile, which causes a fluctuation in pH (Heylar, 1976). The process of nitrification produces acid thereby lowering pH. The process of denitrification creates alkaline conditions and counters the acid production from nitrification (APHA, 1992). And a third mechanism is the removal of inorganic cations at greater concentrations than anions in plant products (Riley and Barber, 1969). The removal of inorganic cations (i.e. Mg++, Ca++) affects the buffering capacity of the soil. If an acidic pulse were introduced, the soil would not be able to absorb the acid, causing a decrease in pH. However, a study conducted in Australia at the School of Agriculture at the University of Western Australia indicated that the addition of plant material increased the pH and buffering capacity of the soils or left them unchanged, and that the accumulation of plant material did not necessarily decrease soil pH (Ritchie and Dolling, 1985).

In other adsorption studies, results indicated that soil pH was the primary cause controlling the relationship between the metals and the soils (Lair et al., 2006). As soil pH rises, the solubility of soil organic matter also increases. This increases the mobility and possibly the bioavailability of heavy metals by one of two methods. First, soluble organic matter binds the heavy metal ion forming an organic-metal complex. Or second, the soluble organic matter competes with the heavy metal ion for sites on the soil particle (Temminghoff et al., 1997; Lair et al., 2006). In the same study, the dissolved organic matter competed with the copper ion for charged sites, resulting in maximum adsorption of the dissolved organic matter onto soil solids at pH 4-5 (Lair et al., 2006). Temminghoff et al. (1997) found decreased copper adsorption with decreasing pH, resulting in 30% copper adsorption onto dissolved organic matter at pH 3.9 and 99% of copper adsorption onto dissolved organic matter at pH 6.6. Thus, the combination of an increase in soil pH and amount of soil organic matter leads to higher adsorption of the copper ion (Lair et al., 2006).

Alkalinity/Hardness

The alkalinity and hardness within a soil system is attributed to the mineral content of the soil when moisture is added. Alkalinity and hardness control the pH of the soil. In effect, they control many reactions within the soil. Hardness generally represents the presence of polyvalent cations, in particular calcium and magnesium (APHA, 1992).

Alkalinity is a measurement of a system's buffering capacity, the ability to resist a change in pH. It is measured as the sum of all titratable bases. Therefore, the higher the alkalinity, the greater the system's ability to absorb a change in pH. The buffering mechanisms are primarily bases such as bicarbonate and carbonate. Alkalinity is reported as CaCO₃ mg/L because the carbonate ion is the primary base. Other bases include hydroxide, borates, silicates, phosphates, ammonium, sulfides, and organic ligands. Typically, a good buffer system has an alkalinity level between 100 and 200 CaCO₃ mg/L (APHA, 1992). Hardness is also reported as CaCO₃ because calcium carbonate is more common to cause hardness.

When hardness equals alkalinity, the significant cations present are calcium and magnesium. When hardness is greater than alkalinity, there may be significant amounts of other cations present, such as iron (Fe²⁺) and manganese (Mn²⁺) (APHA, 1992).

### BRIEF DESCRIPTION OF THE DRAWINGS

FIG. 1 is a map of the sites. Treasure Island Dump, Bassett Street and Emmajean Road are located in Toledo, Ohio. The Tiffin Landfill is located in Tiffin, Ohio.

FIG. 2 shows the average percent copper mass adsorbed onto the Treasure Island, Bassett Street, Tiffin Landfill and Emmajean soils across various copper concentrations ranging from 1 to 200 ppm. Each sample consisted of 25 ml of copper standard and 1 g soil. All samples were run in triplicate and the averages are plotted. Each site symbol is accompanied by a two-standard deviation error bar that is based on the triplicate analysis. Negative values imply copper desorption.

FIG. 3 shows the average percent copper mass adsorbed on soil versus pH. The negative values indicate copper is desorbing from the soils.

FIG. 4 Changes in pH for copper standard solutions at concentrations between 1 and 200 ppm. Prior to contact with the soils, the pH of the copper solutions was measured. The batch adsorption samples were run in triplicate. After 24 hour contact with the soil, the pH was measured again. The bar graph illustrates the pH of the original copper solutions (grid) is much lower prior to contact with the Treasure Island (dots), Basset Street (horizontal hatch), Tiffin Landfill (vertical hatch) and Emmajean (diamonds) soils. The pH of the 100, 150 and 200 ppm solutions is recorded to be 3.8, the lowest value on the pH paper.

### EXPERIMENTAL PROTOCOLS

Historical Review of the Sites

2.1.1 Treasure Island Dump

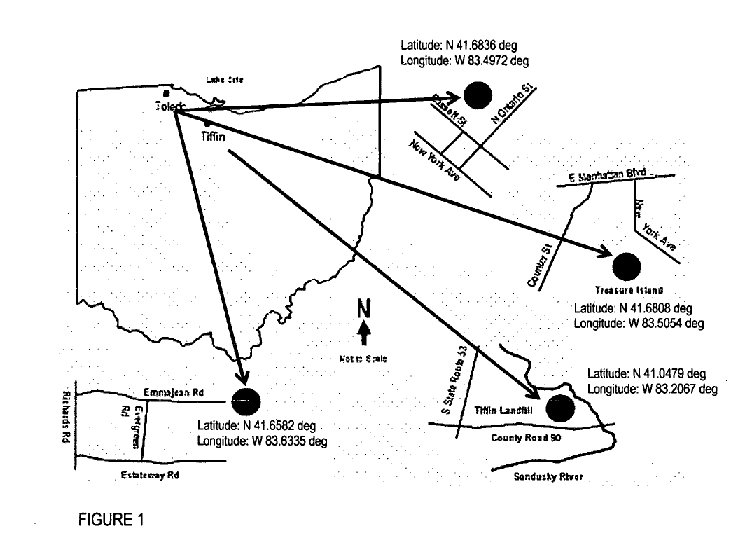

Treasure Island Dump, a municipal and industrial waste dump, has a footprint of 5.3 hectares and lies adjacent to the 9.3 hectare Manhattan Dump (FIG. 1). Treasure Island stopped receiving waste in 1968 (Mannik & Smith, 2006) and is currently listed as a Super Fund Site (USEPA, 2000).

In 1981, Owens-Illinois, Inc. and Libbey Plant 27, a glass manufacturing plant, submitted a CERCLA Notification of Hazardous Waste Site (103[c]) form listing unknown quantities of arsenic and heavy metals at the site. In 1993, a screening site inspection was conducted by PRC Environmental Management, Inc. Groundwater, surface water and sediment samples were tested to determine the presence and concentrations of contaminants. Semi-volatile organic compounds, pesticides and heavy metals were confirmed at the site (Mannik & Smith, 2006).

The City of Toledo acquired Treasure Island in the mid 1990's and had placed a 6 to 12 inch thick soil and clay layer to cap the dump (Mannik & Smith, 2006). Today, approximately half of the western side of Treasure Island Dump has been regraded with fill-dirt and a new recreational park is being built. The eastern half of the landfill has dense plant communities with large stands of older trees, suggesting limited disturbance. The site has several ponds with a combination of trees, shrubs, and plants growing on the banks. The remainder of the site, located away from the banks, is sparsely dotted with vegetation, mostly grasses and small forbs. There are a few unpaved dirt roads that run through the site to access the ponds. A playground and picnic area have also been developed on the site. The topography is primarily flat with a few large mounds of soil pushed up by earth moving equipment.

2.1.2 Bassett Street Warehouse

The Bassett Street Warehouse site, a former manufacturing and hazardous waste storage facility, is 1.54 hectares in size and listed as a brownfield with the City of Toledo (FIG. 1). The property had been used for a variety of heavy industrial and commercial purposes since the mid-1890s. Many of the businesses handled toxic chemicals, such as solvents, numerous petrochemicals, and chemicals for photographic development and dry cleaning. Other businesses, such as an automotive repair facility, required constant vehicle traffic over the property, (Mannik & Smith, 2004). Bassett Street Warehouse is located south of Manhattan Marsh. In 1992, approximately 350 drums containing various hazardous wastes were found inside the warehouse and the EPA completed emergency removal and destruction of the warehouse. No further remedial action has been taken. The Bassett Street Warehouse is currently listed as a Super Fund Site (USEPA, 2000).

In 2000, a Phase II Environmental Site Assessment was conducted by Midwest Environmental Consultants (MEC), Inc., a member of The Mannik and Smith Group, Inc. The Phase II was conducted for the City of Toledo to assess the potential environmental liabilities prior to the acquisition of the property. The site contains the remnants of the warehouse (concrete foundation, brick, wood, and metal), which was destroyed by arson in 1993. Upon inspection of the site by MEC, there were several noticeable areas where opportunistic dumping (construction and demolition debris) had taken place. MEC had estimated that approximately 4,673 to 9,345 cubic meters of construction and demolition debris had been dumped at the site. MEC also estimated that there were approximately 300 to 400 large truck tires dumped at the site.

The Phase II included the analysis of ten soil borings to test for contaminants (MEC, 2000). The results of the analytical soils data detected no presence of polychlorinated biphenyls (PCBs). Several volatile (VOC) and semi-volatile organic compounds (SVOC) were detected but all were found to be below Ohio's Voluntary Action Program Single Parameter Residential or Commercial Standards (VAP standards). Contrary to my findings (Section 3.6), heavy metals were detected at the site but arsenic was the only metal above the VAP standards.

Methylene chloride was detected in a soil pile at a concentration of 84 parts per billion (ppb). The presence of barium, chromium and lead were also detected but all were reported below the VAP standards. Found near the northeastern edge of the site, at Soil Boring No. 10, a thick sand sequence was uncovered, believed to be fill material from foundry sand.

In 2004, The Mannik & Smith Group conducted a Phase II Property Assessment of the Bassett Street Warehouse site for the City of Toledo. The results of the Phase II confirmed the presence of VOCs, SVOCs and RCRA metals. None of the VOCs present were above the VAP standards. The following SVOCs were detected to be above the VAP standards: benzidine, solvent, plastics hardener, benzo(a)anthracene, benzo(a)pyrene, benzo(b)fluoroanthene, and dibenzo(a,h)anthracene. The RCRA metals reported to be above the VAP standards were arsenic (37 ppm). Even though lead was reported to be below the VAP standards, the lead concentration was high at 1200 ppm. Joe Hickey's laboratory analyses also confirmed the presence of high levels of copper (Section 3.6).

The land surrounding the former location of the warehouse is sparsely dotted with vegetation, mostly grasses and forbs. The Bassett Street soil is the original heterogeneous soil. The terrain is flat and the site has been used as a construction dumpsite, with piles of broken concrete scattered throughout. There still exists a large concrete pad on the site. There are still small areas of exposed soil.

2.1.3 Tiffin Landfill

The Tiffin Landfill, located in Tiffin, Ohio (FIG. 1), has a footprint of 16.19 hectares, of which 8.09 hectares was used for municipal and industrial landfill operations. The Tiffin Landfill, an unlined facility, received municipal and industrial waste from 1956 to 1972 (ATSDR, 2001). The landfill cap is composed of fill material and is sloped towards the ditch line surrounding the landfill where the water is transported to the area's stormwater system to direct runoff away from the landfill. The top of the landfill cap is well vegetated with tall grasses, forbs and small stands of trees. A passive gas system was installed to vent methane that is created from the decomposing organic matter. The Tiffin Landfill did not have a soil analysis of contaminants conducted since landfill operations ceased prior to the passage of the Clean Water Act (Ohio EPA, 2006). However, Joe Hickey's laboratory analyses confirmed the presence of high copper concentrations (Section 3.6). The topography of the landfill cover is uneven but relatively flat.

2.1.4 Emmajean Reference Site

As stated previously, the Emmajean site was chosen to be the reference site due to the soil type, the location and the condition of the land, which has not experienced direct industrial impact or disturbance for the past few decades. The soil type is the Del Rey series, a very common soil in the state of Ohio (USDA, 1980). The Emmajean soil makes for a good comparison for soil conditions pertaining to plant growth and adsorptive capacity of the soils and could possibly be used as a soil amendment in contaminated areas where plant growth is limited. If results indicate the Del Rey series has favorable properties for plant growth and phytoremediation, then costs can be greatly reduced in terms of transport of materials and the purchasing of soil amendments needed to manipulate the pH. Plants were not collected at the Emmajean site to test for copper concentration. The Emmajean site is located at the end of Emmajean Road in a residential area in Toledo, Ohio, and is the property of one of the homeowners. The site consists of a small stand of densely packed small trees, and a few shrubs.

Plant Copper Analysis

1) Subject Plants: The plants collected for the analysis are listed in Table 1 and were chosen for analysis based on their abundance at the sites.

Table 1 Summary table of plant and tree seedling species listed by scientific name and common name. The plant location is the site location and site section from where the plant was sampled. Plant copper concentrations were used to calculate the bioconcentration factor (BCF): BCF=plant [Cu]/soil [Cu].

2) All plant parts (roots, stems and leaves) per species were washed in 0.1 N HCl for 30 seconds to separate adsorbed from absorbed copper, re-rinsed in deionized water, and then dried at 70° C. for 48 hours to measure the weight of the dry biomass. The dry biomass was ground in a stainless steel Wiley mill to pass 1 mm screen (20-mesh).

3) The plants were digested in an acid solution in a microwave digester using 1 gram (dry-weight) samples.

4) The digested solutions were measured for copper concentration with an inductively coupled plasma optical emission spectroscopy (ICP) device.

Soil Copper Analysis

1) Subject Soils: The Treasure Island, Bassett Street and Tiffin Landfill soils were sufficiently air dried and individually ground using mortar and pestle. Each individual sample was stirred to homogenize, resulting in three samples, each from their respective sites. The soils were not sieved but gravels and pieces of decaying plant material were removed.

Table 3 is the list of plant species that have an average BCF greater than 0.5*.

2) The soils were digested in an acid solution in a microwave digester using 1 gram (dry-weight) samples.

3) The digested solutions were measured for copper concentration with an inductively coupled plasma optical emission spectroscopy (ICP) device.

Total Organic Matter

1) Subject Soils: The Treasure Island, Bassett Street and Tiffin Landfill soils were measured for total organic matter using the loss on ignition method (De Vos et al., 2005).

2) The mass of the foil tins was weighed and recorded. Approximately 25 to 30 g soil samples was added to the foil tins and dried at 105° C. for 24 hours, cooled for 24 hours, weighed and recorded. The mass of the foil tin was subtracted from the total mass.

3) The samples were then placed in a muffle furnace for 5 hours at 450° C. The ignited samples were re-hydrated and dried at 105° C. for 24 hours, cooled for 24 hours, reweighed and recorded.

The mass of the tin was subtracted from the final recording of the total mass. The final mass subtracted from the initial mass yields an estimate of the mass of total organic matter. The total organic matter content, divided by the initial mass of the soil yields the percent total organic matter.

Particle Size Analysis

1) Subject Soils: The Treasure Island, Bassett Street, Tiffin Landfill and Emmajean soils were prepped as in the soil copper analysis.

2) Approximately 5 g of well mixed soil was placed in a Petri dish and enough glacial acetic acid was added to cover the sample to remove carbonates. Enough water was added to avoid complete evaporation of the liquid while sitting under the hood for a period of 24 hours. A volume of 15 ml of 5% hydrogen peroxide was added to the Petri dish to remove organics and let sit for an additional 24 hours. Excess fluid was removed using a pipette.

3) To encourage separation of the soil particles, 15 ml of 40% sodium hexametaphosphate was added and let sit for 24 hours. The sample was then re-suspended in Nanopure water.

4) The particle size of 1 g samples was determined by laser diffraction. The samples were introduced into the instrument using a medicine dropper. The particles were classified according to ASTM standards.

Batch Adsorption Experiments: Laboratory Analysis and Adsorbed Copper Calculations

1) Subject Soils: The Treasure Island, Bassett Street, Tiffin Landfill and Emmajean soils were prepped as in the soil copper analysis. In the explanation that follows, the lettered columns referred to are for Tables A1 to A4: Table A1 Treasure Island Dump Adsorption Results, Table A2 Bassett Street Warehouse Adsorption Results, Table A3 Tiffin Landfill Adsorption Results, Table A4 Emmajean Adsorption Results, the spreadsheet calculations.

2) Copper Standards: Each copper standard (1, 5, 10, 25, 50, 100, 150 and 200 ppm) was prepared and measured by ICP spectrometry to verify initial copper concentrations (C_{0,ICP}, Column C) and calculate initial copper mass (M₀, Column D).

3) Soil samples of 1 g (SM, Column N) were immersed in 25 ml aqueous solutions consisting of copper concentrations of 1, 5, 10, 25, 50, 100, 150 and 200 ppm in Nalgene centrifuge tubes, hand shaken to suspend the soil particles and placed on a shaker table for 24 hours with continuous agitation. Each standard was run in triplicate.

4) Without disturbing or removing the settled soil particles, as much solution as possible was extracted from each centrifuge tube using a Pipetteman auto-pipette. The quantity of fine soil particles suspended in the centrifuge tube determined how far the pipette tip could be extended into the solution, thus accounting for the varying aliquot volumes of 10, 15 or 20 ml (V_{A}, Column E). The aliquots were filtered with a #41 Whatman filter paper into 25 ml glass vials to catch soil particles that could damage the ICP.

5) In the case of the Tiffin Landfill soils, the aliquots were diluted by a factor of 20 percent (DF, Column F) by adding a volume of Nanopure water equal to four times the aliquot volume. This was necessary because the copper concentration in the Tiffin Landfill samples was too high to be measured by the ICP instrument. For the other soils, no dilution was needed and so the ‘dilution factor’ was equivalent to 1 and thus omitted from the corresponding Figures.

6) A volume of 9.7 ml of the filtered aliquots were transferred to 10 ml ICP tubes and treated with concentrated (commercial grade, 15.8 Molar) nitric acid, three percent by volume of the ICP tube (0.3 ml), a step required by the ICP instrument to ensure same pH levels of all samples. To account for the dilution effect of the addition of the acid over the total volume of 25 ml, I used three percent (0.03) by volume as the correction factor in the spreadsheet calculation (A (% by volume), Column G).

7) From the above analytical results, the amount of copper adsorbed by the soil samples was calculated as follows.
STEP 1: Find the mass of copper in the original solution (M₀ in mg, Column D).

$${M}_{0} = {C}_{0 , ICP} \times {V}_{0} \times ( \frac{0.001 l}{1 ml} ) \times ( \frac{\frac{1 mg}{l}}{1 ppm} )$$

Where: C_{0,ICP} is the copper concentration (in ppm) measured by ICP in the original solution (Column C; note that 1 ppm=1 mg/I)
   V₀ is volume of the original solution, which is 25±0.02 ml (note that 1 ml=0.001 l). For the calculations, 0.025 l was used.
STEP 2: Apply the corrections for acid content and, where necessary, dilution factor to the copper concentration measured by ICP in the aliquot (C_{A,COR} in ppm; Column I).

$${C}_{A , COR} = ( \frac{1}{DF} ) \times {C}_{A , ICP} + ( {C}_{A , ICP} \times A )$$

Where: C_{A,ICP} is the copper concentration (in ppm) measured in the aliquot by ICP (Column H).
   DF is the dilution factor (dimensionless), which is always 0.2 (Column F)
   A is the percent by volume of acid, which is always 0.03 (Column G)
Note that if there was no dilution of the original solution, the first term in the above equation drops out.
STEPS: Find the mass of copper in the aliquot (M_{A} in mg, Column J)

$${M}_{A} = {C}_{A , COR} \times {V}_{A} \times ( \frac{0.001 l}{1 ml} ) \times ( \frac{\frac{1 mg}{l}}{1 ppm} )$$

Where: C_{A,COR} is from Step 2 (note that 1 ppm=1 mg/l)
   V_{A} is the aliquot volume (in ml, Column E; note that 1 ml=0.001 l)
STEP 4: Calculate the mass of copper in the original 25 ml solution after 24 hours (M_{T} in mg, Column K) based on M_{A} from Step 3 and assuming that the copper ions were uniformly distributed throughout the original solution.

$${M}_{T} = ( \frac{{V}_{0}}{{V}_{A}} ) \times {M}_{A}$$

Where: V₀ is from Step 1
   M_{A} and V_{A} are from Step 3
STEP 5: Find the mass of copper remaining in the original solution after removal of the aliquot (M_{R} in mg, Column L)

M_{R}=M_{T}−M_{A}
Where: M_{A} is from Step 3
   M_{T} is from Step 4
STEP 6: Find the mass of copper adsorbed by the soil sample (M_{S} in mg, Column M)

M_{S}=M₀−M_{A}−M_{R}
Where: M₀ is from Step 1
   M_{A} is from Step 3
   M_{R} is from Step 5

Note that when using contaminated soils, negative values will occur when the contaminant is desorbing from the soil particle and going into solution. Such soils are ideal candidates for phytoremediation.
STEP 7: Find the mass of copper adsorbed by the soil sample in units of mg/kg (M_{S,mg/kg}, Column O)

$${M}_{S , mg / kg} = ( \frac{{M}_{S}}{SM} ) \times ( \frac{1000 g}{1 kg} )$$

Where: MS is from Step 6
   SM is the mass of soil (g) originally placed in the centrifuge tube (Column N)

Batch Adsorption Experiments: Partition Coefficient (K_{d} Value) Calculations

1) The adsorptive capacity of a soil is quantitatively represented by the partition coefficient, also known as the K_{d} value (Tables A1 to A4, Column R). The K_{d} value is a ratio that describes the relationship between the solid and aqueous phases of a constituent, specifically, the quantity of adsorbate adsorbed per mass of substrate to the amount of adsorbate remaining in solution at equilibrium (USEPA, 1999). To calculate the K_{d} value, an empirical model was used due to the heterogeneity in texture of the Ohio soils used for the batch method (EPA, 1999). The Freundlich and Langmuir isotherms are inappropriate for this method because their use is for homogenous substrates (EPA, 1999). The soils used in this study are composed of fill material, excluding the Emmajean soil (Del Rey Series), which is also a heterogeneous substrate.

2) The following empirical model is based on the premise that the reaction is independent of contaminant concentration in the aqueous phase and that, in striving for equilibrium, desorption is equal to adsorption (reversible process). The premise is based on the assumption that all adsorption sites on the soil particle are created equal and there exists only one dissolved aqueous constituent, giving all ions in solution the same probability of being bound to a site. The reaction is also assumed to take place at fixed pH and temperature (USEPA, 1999). To calculate the K_{d} value (USEPA, 1999):

$${K}_{d} = \frac{{M}_{S , mg / kg}}{{C}_{A , COR}}$$

Where: K_{d}=partition coefficient (l/kg)
   M_{S,mg/kg}=copper mass adsorbed on the substrate (mg/kg), from Step 7 in Section 2.5
   C_{A,COR}=copper mass not adsorbed in aqueous solution (mg/l), from Step 2 in Section 2.5

In Tables A1 to A4, Column I (C_{A,COR}) has zero values at the copper concentrations from 1 to 10 ppm, excluding the Emmajean site, which has zero values from 1 to 5 ppm. To avoid a zero value for copper concentration (C_{A,COR}) in the denominator, 0.0001 was used for this parameter.

pH, Alkalinity/Hardness

pH

1) The soil pH was tested in the field with a mixture of approximately 2 g of soil to 5 ml of Nanopure water. The soil was taken from a depth of approximately 20 cm.

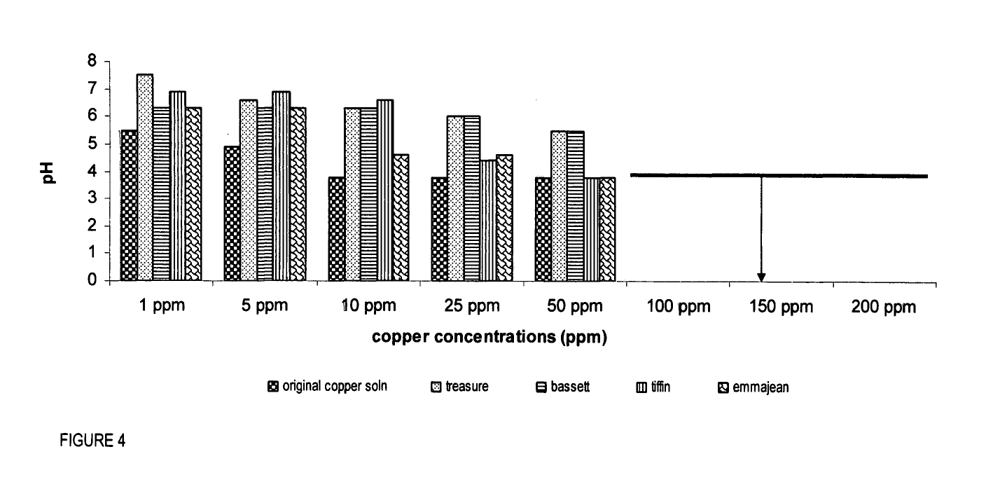

2) The copper solutions used for the batch adsorption experiments were tested for pH differences before and after contact with the soil (FIG. 4).

Alkalinity/Hardness

1) To prepare the soils for analysis, each soil was well mixed to form a composite sample from its respective site. Approximately 100 g of soil was mixed with approximately 500 ml of reverse osmosis water. For the water to develop good contact with the soil particles, the samples were incubated for a period of 24 hours in ambient light conditions and a room temperature of 22° C. The samples were filtered with a Buchner funnel and #41 Whatman filter paper. The following methods were used to determine the alkalinity and hardness of the filtrate. At 24 hours, the pH of the filtrates was recorded prior to begin the alkalinity/hardness tests.

2) Alkalinity and hardness were determined following standard methods and equations published by American Public Health Association (1992).

$$Alkalinity ( \frac{mg {CaCO}_{3}}{l} ) = \frac{A \times n \times 50 \text{,} 000}{ml Sample}$$

Where: A=mL of sulfuric acid used (V_{f}−Vᵢ)
   N=normality of sulfuric acid used

$$50 \text{,} 000 = \frac{50 mg}{meq} \times \frac{1 \text{,} 000 ml}{I}$$

$$Hardness ( \frac{mg {CaCO}_{3}}{l} ) = \frac{A \times B \times 1 \text{,} 000}{ml Sample}$$

Where: A=mL of EDTA (V_{f}−Vᵢ)
   B=mg CaCO₃ equivalent of EDTA
   For 0.01 M solution, B=1 mg CaCO₃=1 mL EDTA 1.000 ml=1 liter

### EXPERIMENTAL RESULTS

Plant and Soil Copper Concentrations and their Associated BCF Results

Table 2 lists the results of the soil analyses for copper concentrations for each section of the sites. The soil samples are listed by site name and section number with the appended A or B (sometimes followed by a number) representing multiple sub-samples from a section. The average copper concentrations of each section were calculated and were used to calculate the BCFs of the plants that were taken from their respective locations. The soil samples are labeled by site name followed by a section number with an appended alphanumeric code, denoting the locations within a section.

Table 3 lists the species that have a BCF greater than 0.5 and the number of samples (n) taken from the site. The number of samples collected at each site varies according to the abundance of the species. In studying the list of plants, the Tiffin Landfill has the plants with the greatest BCF values. To double check the possibility the Tiffin Landfill plants are the best performing plants of the three sites, the plant copper concentrations of the three sites were compared (Table 4).

Table 4 is a summary of the total plant (roots, stems and leaves) copper concentrations of all species. Copper concentrations listed in ascending order. The copper concentration was measured using the dry weight of the plants. The species chosen were the ones with a copper concentration greater than 10 ppm. Table 4 illustrates the Treasure Island and Tiffin Landfill plants have the greatest potential to uptake copper with consistently the highest copper concentrations in the plant tissue. As a predictor of plant copper concentration, the BCF results can be misleading. A plant with a low BCF could result from a high concentration of copper in the soil but the plant could have the highest copper content in its tissues. Note that the highest copper levels are encountered in a species of tree.

Table 5 lists the plants that are common to two and three sites and also serves as a quick comparative analysis of how the plants perform. Some of the plants perform about the same among the sites (Cichorium intybus, Chenopodium album, Phragmites australis). Other plants vary widely in their uptake ability (Cirsium arvense, Solidago sp., Parthenocissus quinquefolia, Rhus glabra).

Table 5 shows the copper concentrations distributed throughout the sites are different. The varying copper concentrations in the same species of plant suggest that different conditions exist at each location that influence the plants to have different uptake abilities. Bassett 2 and Tiffin 2 have the highest soil copper concentrations, averages of 186.89 and 238.87 ppm, respectively. The plants in Bassett 2 consistently have the lowest copper concentrations in their tissues.

Bassett Street consistently has the least amount of plants growing at the site and all of the plants have a copper concentration of around 10 ppm. There are two probable explanations why the Bassett Street plants are having difficulty growing and removing copper from the soil. The first reason could be from competition with the high levels of arsenic and lead, as found in the Phase II Property Assessment conducted by Mannik & Smith. Even though lead was below the VAP, the concentration of lead was determined to be as high as 1200 ppm (Mannik & Smith, 2004). The second and most probable reason is the heavy industrial use that the site had experienced for over 100 years, and, there still exists the dumping of construction material at the site. The constant driving over the land with heavy machinery results in compaction of the soil, inhibiting plant growth.

Organic Matter and Particle Size Analyses

Table 6 displays the average particle size distributions and percent organic matter. The results are classified in accordance with ASTM Standards according to diameter (d) of the particle size: Clay<5.00 microns (μm); 5.00 μm<silt>74.00 μm; and 74.00 μm>sand, with their standard deviations in parentheses. The results of percent organic matter were calculated using loss on ignition method. The soils with the most favorable characteristics for adsorption are the Treasure Island and Tiffin Landfill soils with the highest amounts of clay and silt. Though none of the soils can be classified as organic, the relatively high amount of organic matter (8.0%) in the Emmajean soil is favorable for adsorption and phytoremediation. The higher amount of organic matter also contributes to favorable growing conditions for vegetation. The vegetation at the Emmajean site consisted primarily of a dense stand of trees and shrubs. The other sites have relatively the same amount of organic matter, ranging from 2.5% to 3.7%, which have the potential to provide conditions that are favorable for adsorption and phytoremediation of the copper ion even with a high fraction of sand content, due to the natural properties inherent in organic matter.

Copper Adsorption

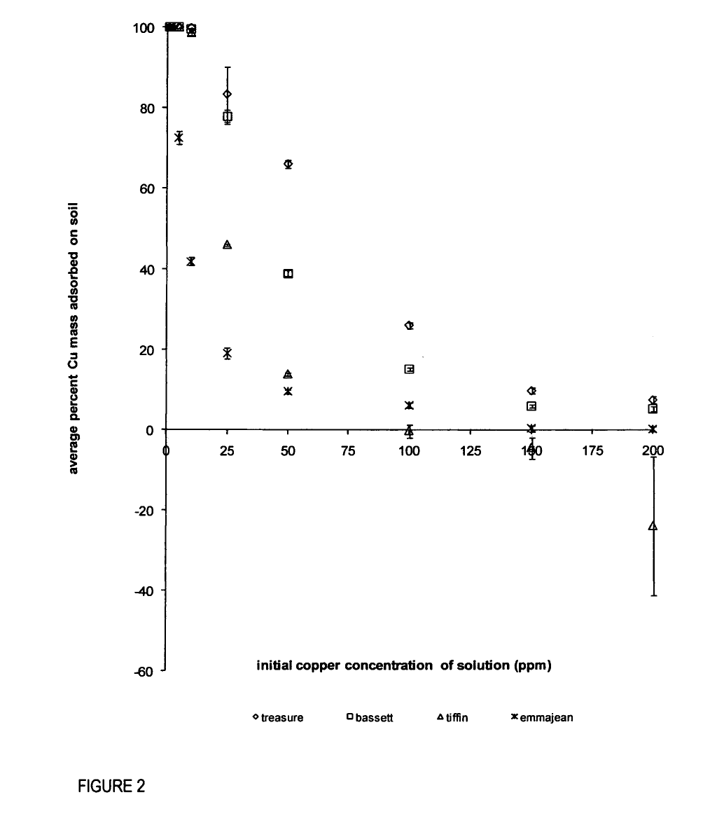

FIG. 2 is a scatter plot and displays the variation in copper adsorption for each soil. The initial copper concentration (ppm) of the standard solution is graphed on the abscissa and the average percent copper mass adsorbed on soil is graphed on the ordinate. The graph illustrates the percent copper mass adsorbed for each initial copper concentration after a period of 24 hours of contact with the soils. Because some of the soils used for this study are contaminated with copper (excluding Emmajean), there are negative numbers, indicating that copper is desorbing from the soil particles. For example, for Treasure Island at 200 ppm, the average percent copper mass adsorbed is less than 10 percent, which implies, at high copper concentrations, less mass is adsorbing to the soil particle.

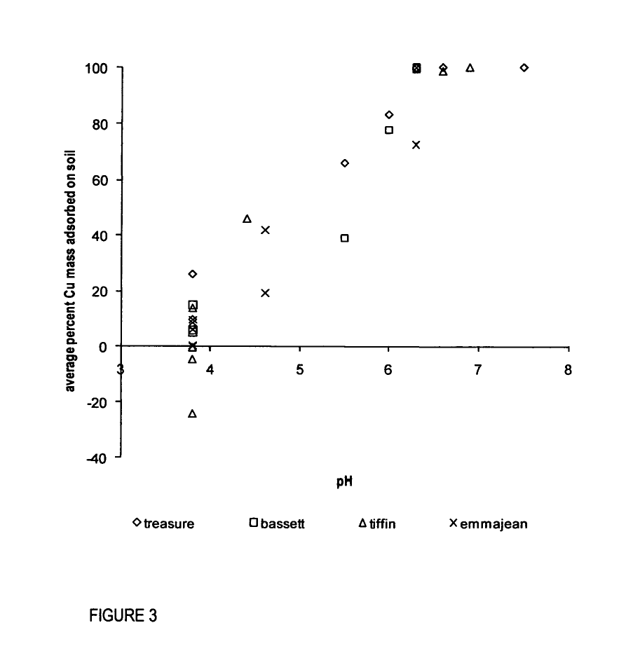

FIG. 3 is a scatter plot displaying the relationship between the average percent of copper mass adsorbed onto soil versus pH levels. At copper concentrations of 1 to 10 ppm, 100% adsorption occurs for Treasure Island, Bassett Street and Tiffin Landfill soils. At concentrations greater than 10 ppm, less mass is adsorbed and more mass remains in solution. At pH levels less than 6, little copper mass is adsorbed, versus at pH levels greater than 6.5 when almost 100% of the copper mass is adsorbed. At pH values less than four, negative values indicate that copper is desorbing from the soils.

Table 7 summarizes the copper mass adsorbed at each concentration, the respective K_{d} values and the pH of the copper solution. All samples were run in triplicate with the results provided in Tables A1 to A4. The mass adsorbed was calculated from the copper concentration results from the ICP analysis. The K_{d} value is a ratio of the quantity of the adsorbate adsorbed per mass of solid to the amount of the adsorbate remaining in solution at equilibrium.

With the exception of the Emmajean reference site, all soils adsorb 100% of the copper mass at 1 ppm in the pH range from 6.3 to 7.5. The Treasure Island, Bassett Street and Tiffin Landfill soils are able to adsorb 99 to 100% of the copper mass up to and including 10 ppm in the pH range from 6.3 to 6.9. The Emmajean soil begins to lose its adsorptive capacity at 5 ppm at pH 6.3, which suggests the soil is extremely limited in its ability to adsorb the copper ion.

At 10 and 25 ppm copper in solution, the Emmajean soil/solution mix has a pH of 4.6 and the copper mass adsorbed is much lower than the other soils. At 25 ppm, the Treasure Island and Bassett Street soils have a pH of 6.0 and the Tiffin Landfill soil's pH has decreased to 4.4. The Tiffin Landfill soil is only able to adsorb approximately 60% of the mass the Treasure Island and the Bassett Street soils adsorb at that exposure.

At levels of 50 ppm copper in solution, the pH drops to 3.8 for both the Emmajean and Tiffin Landfill soil and the amount of copper the Tiffin Landfill soil is able to adsorb has dramatically decreased. Although the pH for Treasure Island and Bassett Street is 5.5, the Treasure Island soil is still able to adsorb the most copper. The Bassett Street soil maintains approximately the same copper mass adsorbed at 25 and 50 ppm, which are at pHs 6.0 and 5.5, respectively. The pH of the solutions decreases due to the stock solution being preserved with 2 percent by volume nitric acid, meaning that in 500 ml of copper stock solution, 10 ml is nitric acid. Therefore, the more copper stock solution used to make a copper standard, the more acidic the standard becomes.

At 100 ppm copper in solution, the Treasure Island and Bassett Street soils are now experiencing a decrease in the amount of copper they are able to adsorb. The Tiffin Landfill soil is now desorbing copper, represented by the negative values for the response variable. The Emmajean soil has maintained roughly the same adsorptive capacity from 5 ppm to 100 ppm.

At 150 and 200 ppm copper in solution, the copper mass adsorbed by the Treasure Island and Bassett Street soils is approximately the same per their respective performance. The Tiffin Landfill soil is beginning to desorb a greater quantity of copper, increasing desorption at 200 ppm. The Emmajean soil is not able to adsorb copper at 150 ppm and begins to desorb copper at 200 ppm (FIG. 2), as depicted by the negative values.

The K_{d} values associated with each copper concentration depict the adsorptive ability of each soil. The K_{d} values at the low concentrations are extremely high, representing the soils' ability to adsorb 100% or close to 100% the copper mass in solution. As the copper concentrations increase and the pH decreases, the K_{d} values decrease. When the copper begins to desorb from the Tiffin Landfill and Emmajean soils, the K_{d} values become negative.

Excluding the Emmajean soil, at low concentrations of copper (1 ppm to 10 ppm) and at neutral or close to neutral pH, the soil could be sequestering the copper. Although the K_{d} values support that sequestration is occurring, a simple leach test could be conducted to actually determine if sequestration is occurring. If sequestration is occurring in the 1 ppm to 10 ppm concentrations, then there would not be a need to conduct clean up procedures at the site.

At the higher concentrations of copper solution and low pH, the opposite occurs. The K_{d} ratio is decreased meaning there is more adsorbate in solution than adsorbed to the soil particles. Therefore, the copper ion, remaining in solution, has the potential to be bioavailable to the plants for uptake.

FIG. 4 is a bar graph showing the pH of the batch adsorption copper solutions before and after contact with the soil. The results indicate that the Treasure Island and Bassett Street soils have the greatest capability to buffer an acidic input. The Tiffin Landfill soil begins to lose its buffering capability before both the Treasure Island and Bassett Street soils. The low-alkalinity Emmajean soil has even less buffering capability.

pH, Alkalinity/Hardness

Table 8 shows the soil pH, alkalinity and hardness results and a hardness:alkalinity ratio was calculated. Soil pH was analyzed on-site. The pH results indicate the soils maintain a pH that is close to neutral or neutral. The column with pH_{filtrate} is the pH of the mixture of reverse osmosis (RO) water and soil after 24 hours. The results indicate the Treasure Island, Bassett Street and Tiffin Landfill soils are buffering the pH of the RO water with a pH of 6.9. The results of the Emmajean filtrate demonstrate that the soil has very little alkalinity, meaning the conjugate bases that are able to resist a change in pH are not present.

The results of the alkalinity test indicate that the Treasure Island and the Tiffin Landfill soils have good buffer systems with alkalinity values of 102 and 122 mg CaCO₃/L, respectively. The Bassett soil has an alkalinity value of 69 mg CaCO₃/L, which is indicative of some buffering capacity. The Emmajean soil has little buffering capabilities with an alkalinity value of 20 mg CaCO₃/L.

The Treasure Island, Bassett Street and Emmajean soils have a hardness of 42, 39 and 31 mg CaCO₃/L, respectively, placing the soils in the “soft” category (APHA, 1992). The Tiffin Landfill soil has a hardness of 89 mg CaCO₃/L, placing the soil in the “moderately hard” category (APHA, 1992).

Table 8 also lists the hardness to alkalinity ratio. Remembering the relationship between alkalinity and hardness, a ratio (hardness/alkalinity) can be calculated to describe the buffering capabilities of a soil: the lower the value, the higher the buffering capability and vice versa. A value greater than one is indicative of the presence of significant amounts of other cations.

With regards to the Bassett Street soil, adding to the poor soil conditions is the good buffering capability of the soil. The hardness to alkalinity ratio of 0.57 illustrates the soil has a very good buffering capability. Therefore, the combination of unfavorable soil conditions for plant growth and the buffering capability of the soil would result in poor uptake ability of the plants. The results of Table 7 support the soil is able to buffer an acidic pulse and adsorb the copper ion relatively well down to a pH of 5.5, which results in the copper ion being unavailable to the plant for uptake.

The Tiffin Landfill soil has a higher hardness to alkalinity ratio (0.73) and is not able to buffer acidic pulses as well as either the Treasure Island or Bassett Street soils. The Tiffin Landfill begins to lose its buffering capability before both the Treasure Island and Bassett Street soils (Table 7). With a slight acidic pulse, the pH is lowered and the copper becomes mobile, possibly making the copper ion bioavailable to the plants.

The Treasure Island plants perform better than the Bassett Street plants, even though the hardness to alkalinity ratio (0.41) is much lower (Table 8). Remembering that upon acquisition of the dump, the City of Toledo had placed a 6 to 12 inch soil and clay cap over Treasure Island. The newly applied soil provided favorable growing conditions for plants.

The results of the pH, alkalinity and hardness analyses indicate that the controlling factor for copper mobility is alkalinity. The alkalinity of the soil system must be overburdened by an acidic or basic pulse in order for a change in pH to occur. In the lab analyses, I introduced an acidic pulse at varying concentrations. When the soils began to lose their buffering capacity, the pH decreased resulting in greater mobility of copper in the soil.

### INDUSTRIAL APPLICABILITY

The results of this study indicate that conducting soil physical and chemical analyses is a feasible process in order to know the soil conditions that control the uptake ability of the plants. The soil parameters that control adsorption of copper include organic matter content, clay content pH, alkalinity and hardness. These are the same soil parameters that create favorable or unfavorable conditions for plant growth. Moreover, these are the same parameters that may inhibit or permit the removal of a contaminant by plants.

The copper concentrations of the plants in Table 4, infer the plants located at the Treasure Island and Tiffin Landfill sites have the best potential to be good accumulators. Comparing the copper concentrations of the plants that are common to two and three sites, an assumption would be the plants would perform approximately the same. Cirhorium intybus (7 to 10.5 ppm), Chenopodium album (14 to 18.6 ppm) and Phragmites australis (5.6 to 8.4 ppm), remove copper at approximately the same rate between the sites. However, the species that have a wider range of copper concentrations are Populus deltoides (0.4 to 15.7 ppm), Solidago spp. (6.3 to 14.2 ppm), Parthenocissus quinquefolia (5.4 to 17.5 ppm) and Rhus glabra (4.1 to 14.2 ppm). Demonstrated in the results, the adsorptive capacity of the soil and the soil contaminants and conditions vary by site. Adding a soil amendment to improve soil chemistry is one approach to improve copper uptake by plants. Manipulating the microbial communities around the root zones may also be effective but is likely more complex to accomplish. Improving oxygen content in the soils through plowing is another option, keeping in mind that increased oxygen levels may affect pH levels and copper mobility.

Table 9 summarizes the parameters that influence the adsorption of soil, uptake ability of plants and plant growth. The prediction that at low pH levels and high copper concentrations, more copper will remain in solution, and vice versa, came true in the batch adsorption analyses. Looking at the results of Tables 9 and 7, what can be done to the Treasure Island and Tiffin Landfill soils to optimize the plant uptake even further? The alkalinity could be reduced by adding peat moss, leaf mold, and well-composted sawdust, or possibly the Emmajean soil (Del Rey series) due its non-alkaline nature and is found in abundance in Ohio. Also, plant growth might be increased by adding the Emmajean soil, which has a high fraction of sand that will enable the roots to spread out and the organic matter will provide the nutrients needed for plant growth.

According to the site history, Bassett Street has a high amount of contaminants and poor soil conditions from heavy industrial use for over 100 years. The most probable reason there is sparse vegetation at the site is due to the compaction of the soils from the constant vehicle traffic required for heavy industry operations. Not to mention, there continues to be dumping of construction material at the site. The Bassett Street soil also has the most neutral pH of 7.2. Copper sorption was greatest at the higher pH values, which would inhibit the uptake ability of the plants. To improve soil conditions, I would first clear the site of the construction material. Then, to give plants the opportunity to spread their roots, I would turn the soil to at least one foot in depth and add an additional one foot layer of topsoil. Also, to bring the pH down, a soil amendment could be added, such as peat moss, leaf mold, and well-composted sawdust.

The Emmajean soil has little ability to buffer an acidic pulse, indicated by the low alkalinity and hardness values. The soil has very little silt and clay, and the highest percent of sand and organic matter. Even though the Emmajean Kd value is 65.763 L/kg, the maximum adsorptive capacity occurred at 5 ppm, indicative the Emmajean soil has extremely little adsorptive properties. The Emmajean soil could be used as a soil amendment, such as in Bassett Street, to help plant growth without fear of creating conditions that would increase the adsorptive capacity of the soil.

Assuming the historical land use, contaminants and contaminant properties (polar, non-polar, hydrocarbon, heavy metal, etc.) are known, a comprehensive data analysis of the parameters that control the natural conditions of soil adsorption and plant uptake will enable the creation of experiments designed around the manipulation of soil conditions in order to optimize plant uptake of contaminants. This method can be implemented anywhere in the world to economically evaluate the natural chemical and physical properties of soils and plants.

### REFERENCES

1. Agency for Toxic Substances & Disease Registry (ATSDR), Department of Health and Human Services, http://www.astdr.cdc.gov/hac/PHA/formertiffin/ftl_pl.html, 2001.
2. Amethyst Galleries, http://mineral.galleries.com/minerals/silicate/clinopti/clinopti.htm, 1999.
3. Allrichs, J. L., “The soil environment,” Organic Chemicals in the Soil Environment, 1972. Dekker, New York. 1: p. 3-26.
4. Anderson, D. C., Smith, C., Brown, K. W., “Organic solvent effects on the permeability of clay soils,” Land Disposal of Hazardous Waste, 1982. Cincinnati, Ohio, EPA-600/9-82-002: p. 119-130.
5. Apak, R., in: A. Hubbard (Ed.), Encyclopedia of Surface and Colloid Science, Dekker, New York, 2002, p. 385.
6. APHA, Clesceri, L. S., Greenberg, A. E., Eaton, A. D., Eds., Standard Methods 18^{th} Edition, For the Examination of Water and Wastewater. American Public Health Association, 1015 Fifteenth Street NW, Washington D.C., 20005. 1992.
7. Arias, M., Soto, B., Barral, M., “Copper sorption characteristics on mineral-humic acid substrates,” Agrochimica, 2002. XLVI-N(3-4): p. 155-164.
8. Atanassova, I., Okazaki, M., “Adsorption-Desorption Characteristics of High Levels of Copper in Soil Clay Fractions,” Water, Air, and Soil Pollution, 1997. 98: p. 213-228.
9. Bekta [symbol] , N., Kara, S., “Removal of lead from aqueous solutions by natural clinoptilolite: equilibrium and kinetic studies,” Separation and Purification Technology, Volume 39, pg. 189-200. Environmental Engineering Department, Gebze Institute of Technology, Gebze, Turkey. 2003.
10. Bekta [symbol] , N., Akman, B., Kara, S., “Kinetic and equilibrium studies in removing lead ions from aqueous solutions by natural sepiolite,” Journal of Hazardous Materials, Volume B112, pg. 115-122. Environmental Engineering Department, Gebze Institute of Technology, Gebze, Turkey. 2004.
11. Bradl, H. B., “Adsorption of heavy metal ions on soils and soils constituents,” Journal of Colloid and Interface Science, 2004. 277: p. 1-18.
12. Brady, N. C., Weil, R. R., The Nature and Properties of Soils, 12^{th} Ed., Prentice Hall, Inc., Upper Saddle River, NJ. 1999.
13. Brooks, R. R., “Plants that hyperaccumulate heavy metals: Their role in phytoremediation, microbiology, archaeology, mineral exploration and phytomining,” CAB International, New York. 1998: p. 8, 9, 22.
14. Brooks, R. R., Chamber M. F., Nicks, L. J., Robinson, B. H., “Phytomining,” Trends in plant science, 1998. 3(9): p. 359-362.
15. Burden, D. S., Sims, J. L., “Fundamentals of Soil Science As Applicable to Management of Hazardous Wastes,” Ground Water Issue, USEPA 1999. EPA/540/S-98/500
16. Campbell, S., Paquin, D., Awaya, J. D., Li, Q. X., “Remediation of benzo[a]pyrene and chrysene-contaminated soil with industrial hemp (Cannabis sativa),” International Journal of Phytoremediation. 2002; 4(2): p. 157-68.
17. Casagrande, J. C., Jordao, C. B., Alleoni, L. R. F., de Camargo, O. A., “Copper Desorption in a Soil with Variable Charge,” Sci. Agri. (Piracicaba, Braz.), 2004. 61(2): p. 196-202.
18. Choudhury, A. T. M. A., Khanif, Y. M, “Copper Adsorption Behavior of Three Malaysian Rice Soils,” Commun. Soil Sci. Plant Anal., 2000. 31(5&6): p. 567-579.
19. Coulter, Beckman, http://www.beckman.com/coultercounter/homepage_tech_laserdiff.jsp, 2006.
20. Cunningham, S. D., Berti, W. R., “Remediation of contaminated soils with green plants: an overview,” In Vitro Cellular and Developmental Biology, 1993. 29P: p. 207-212.
21. De Vos, B., Vandecasteele, B., Deckers, J., Muys, B., “Capability of loss-on-ignition as a predictor of total organic carbon in non-calcareous forest soils,” Communications in Soil Science and Plant Analysis, 2005. 36(19-20): p. 2899-2921.
22. Deram, A., Petit, D., Robinson, B., Brooks, R., Gregg, P., Van Hallluwyn, C., “Natural and induced heavy-metal accumulation by Arrenatherum elatius: Implications for Phytoremediation,” Communications of Soil Science and Plant Anal, 2000. 31(3&4): p. 413-421.
23. Dijkstra, J. J., Meeussen, J. C. L., Comans, R. N. J., “Leaching of Heavy Metals from Contaminated Soils: An Experimental and Modeling Study,” Environmental Science and Technology, 2004. 38(16): p. 4390-4395.
24. Dowty, R. A., Shaffer, G. P., Hester, M. W., Childers, G. W., Campo, F. M., Greene, M. C., “Phytoremediation of small-scale oil spills in fresh marsh environments: a mesocosm simulation,” Mar Environmental Res. 2001 September; 52(3): p. 195-211.
25. Ensley, H. E., Sharma, H. A., Barber, J. T., Polito, M. A., “Metabolism of chlorinated phenols by Lemna gibba, duckweed,” Phytoremediation of soil and water contaminants. Washington, D.C.: American Chemical Society, 1997. p. 238-253.
26. Farago, M. E., Cole, M., Xiao, X., Candida Vaz, M., “Preliminary assessment of metal bioavailability to plants in the Neves Corvo area of Portugal,” Chemical Speciation and Bioavailability, 1992. 4(1): p. 19-27.
27. Gong, C., Donahoe, R. J., “An experimental study of heavy metal attenuation and mobility in sandy loam soils,” Applied Geochemistry, 1997. 12: p. 243-254.
28. Grassi, M. T., Shi, B. Allen, H. E., “Partition of Copper between Dissolved and Particulate Phases Using Aluminum Oxide as an Aquatic Model Phase: Effects of pH, Solids and Organic Matter,” Journal Braz. Chem. Soc. (Soc. Bras. Quimica), 2000. 11(5): p. 516-524.
29. Hannink, N., Rosser, R. J., French, C. E., Basran, A., Murray, J. A., Nicklin, S., Bruce, N. C., “Phytoetoxification of TNT by transgenic plants expressing a bacterial nitroreductase,” Nature Biotechnology. 2001 Dec. 19(12): p. 1168-72.
30. Hartley, L., Characterization of a Heavy Metal Contaminated Soil in Ohio for a Phytoremediation Project, M. S. Thesis, Department of Environmental Sciences, University of Toledo, Toledo, Ohio. 2004
31. Hausenbuiller, R. L., Soil Science: Principles and Practices, W.C. Brown Co, Dubuque, Iowa. 1978.
32. Heylar, K. R., “Nitrogen cycling and soil acidification,” J. Aust. Inst. Agric. Sci., 1976. 42: p. 217-21.
33. Ingersoll, C. G., Haverland, P. S., Brunson, E. L., Canfield, T. J., Dwyer, F. L., Henke, C. E., Kemble, N. E., Mount, D. R., Fox, R. G., “Calculation and evaluation of sediment effect concentrations for the amphipod Hyalella azteca and the midge Chrionomus riparius”, J. Great Lakes Res. 1996. 22(3): p. 602-623.
34. Janssen, R., Peijnenburg, W., Posthuma, L., Van Den Hoop, M., “Equilibrium Partitioning of Heavy Metals in Dutch Field Soils: I. Relationship Between Metal Partition Coefficients and Soil Characteristics,” Environmental Toxicology and Chemistry, 1997. 16(12): p. 2470-2478.
35. Jiang, L., Yang, X., “Chelators effect on soil Cu extractability and uptake by Elsholtzia splendens,” Journal of Zhejiang University Science. 2004; 5(4): p. 450-456.
36. Khan, A. G., Kuek, C., Chaudhry, T. M., Khoo, C. S., Hayes, W. J., “Role of plants, mycorrhizae and phytochelators in heavy metal contaminated land remediation,” Chemosphere, 2000, 41(1-2): p. 197-207.
37. Khan, M., Bolan, N., MacKay, A., “Adsorption and Desorption of Copper in Pasture Soils,” Communications in Soil Science and Plant Analysis, 2005. 36: p. 2461-2487.
38. Lair, G. J., Gerzabek, M. H., Haberhauer, G., Jakusch, M., Kirchmann, H., “Response of the sorption behavior of Cu, Cd, and Zn to different soil management.” J. Plant Nutrition Soil Science, 2006. 169: p. 60-68.
39. MacDonald, D. D., Ingersoll, C. G., Berger, T. A., “Development and evaluation of consensus-based sediment quality guideline for freshwater ecosystems”, Arch. Environ. Contam. Toxicol, 2000. 39: p. 20-31.
40. Mannik & Smith, Voluntary Action Program, Phase II Property Assessment, 600 Bassett Street, Toledo, Ohio. City of Toledo, Division of Environmental Services, 348 South Erie Street, Toledo, Ohio 43602. November 2004.
41. Mannik & Smith, Ann Arbor Acquisition Corporations, Wheeling Yard Brownfield Redevelopment, 2020 Manhattan Blvd, Toledo, Ohio. City of Toledo, Division of Environmental Services, 348 South Erie Street, Toledo, Ohio 43602. March 2006.
42. McBride, M. B., Environmental Chemistry of Soils, Oxford University Press, New York, 1994.
43. Midwest Environmental Consultants, Phase II Environmental Site Assessment, 600 Bassett Street, Toledo, Ohio. City of Toledo, Division of Environmental Services, 348 South Erie Street, Toledo, Ohio 43602. Sep. 1, 2000.
44. Meagher, Richard B., “Phytoremediation of toxic elemental and organic pollutants,” Current Opinion in Plant Biology. 2000. 3: p. 153-162.
45. Mesquita, M., Carranca, C., Vieira e Silva, J., Gusmao, R., “Effect of Dissolved Organic Matter and pH on Copper Adsorption,” Agrochimica, 2004. XLVIII-N(5-6): p. 222-232.
46. Ohio Environmental Protection Agency, Interview with Solid Waste Division, Bowling Green, Ohio. Dec. 19, 2006.
47. Paschke, A. W., R., Morgenstern, P., “Comparison of 24 hr and Long-term pH stat Leaching Tests for heavy Metal Mobilization from Solid Matrices,” Acta Hydrochim. Hydrobiol., 1999. 27(4): p. 223-229.
48. Proctor, J., “Toxins, nutrient shortages and droughts: The serpentine challenge”, Trends in Ecology and Evolution. 1999. 14(9): p. 334-335
49. PRC Environmental Management, Inc., Screening Site Inspection Report, Treasure Island-Manhattan Dump, EPA Work Assignment No. 29-5JZZ, 1993.
50. Raikhy, N. P., Takkar, P. N., “Copper Adsorption by Soils and its Relations with Plant Growth,” Z. Pflanzenernaehr. Bodenk., 1981. 144: p. 597-612.
51. Raskin, I., Smith, R. D., Salt, D. E., “Phytoremediation of metals: using plants to remove pollutants from the environment,” Current Opinion in Biotechnology, 1997. 8: p. 221-226.
52. Reed, B. E., Matsumoto, M. R., “Modeling cadmium adsorption by activated carbon using the Freundlich isotherm expressions”, Separation Science and Technology, 1993. 28: p. 2179-2195.
53. Reed, B. E., Cline, S. R., “Retention and release of lead by a very fine sandy loam. Isotherm Modeling”, Separation Sci. Technol., 1994. 29(12): p. 1529-1551.
54. Rieuwerts, J. S., Thornton, I., Farago, M. E., Ashmore, M. R., “Factors influencing metal bioavailability in soils: preliminary investigations for the development of a critical loads approach for metals,” Chemical Speciation and Bioavailability, 1998. 10(2): p. 61-75.
55. Riley, D., Barber, S. A., “Bicarbonate accumulation and pH changes at the soybean (Glycine max (L) Merr.) root-soil interface,” Soil Sci. Soc. Am. Proc., 1969. 33: p. 905-8.
56. Ritchie, G. S. P., Dolling, P. J, “The Role of Organic Matter in Soil Acidification,” Australian Journal of Soil Research, 1985. 23(4): p. 569-78.
57. Rock, S., Phytoremediation, Seminar Series on Bioremediation of Hazardous Waste Sites: Practical Approaches to Implementation, Section 8, USEPA. 1996; EPA/625/K-96/001, http://www2.bren.ucsb.edu/˜keller/courses/esm223/biohaz1.pdf
58. Rugh, C. L., Wilde, H. D., Stack, N. M., Thompson, D. M., Summers, A. O., Meagher, R. B., “Mercuric ion reduction and resistance in transgenic Arabidopsis thaliana plants expressing a modified bacterial merA gene,” Proc National Academy of Science USA. April 1996. 93(8): p. 3182-3187.
59. Salt, D. E., Blaylock, M., Kumar, N., Dushenkov, V., Ensley, B. D., Chet, I., Raskin, I., “Phytoremediation: a novel strategy for the removal of toxic metals from the environment using plants,” Biotechnology, 1995. 13: p. 468-474.
60. Sayre, R., “Cure for the Heavy Metal Blues,” Ohio State Synergy. 2001., http://www.biosci.ohio-state.edu/documents/synergy/2000-2001/metal.html
61. Selim, H. M., Iskandar, I. K., Fate and Transport of Heavy Metals in the Vadose Zone, Lewis Publishers, New York, N.Y. 1999.
62. Siciliano, S. D., Germida, J. J., Banks, K., Greer, C. W., “Changes in microbial community composition and function during a polyaromatic hydrocarbon phytoremediation field trial,” Applied Environmental Microbiology. 2003 January; 69(1): p. 483-489.
63. Sposito, G., The Surface Chemistry of Soils, Oxford University Press, New York, 1984.
64. Sposito, G., “Geochemical Processes at Mineral Surfaces,” ACS Symposium Series, American Chemical Society, Washington, D.C., 1986, p. 217.
65. Temminghoff, E., Van der Zee, S., Haan, F., “Copper Mobility in a Copper-Contaminated Sandy Soil as Affected by pH and Solid and Dissolved Organic Matter,” Environmental Science & Technology, 1997. 31(4): p. 1109-1115.
66. Thomson, V., Schatzlein, D., Mercuro, D., “Limits of Detection in Spectroscopy,” Spectroscopy, 2003. 18(12): p. 112-114. http://www.spectroscopyonline.com
67. United States Department of Agriculture, Soil Survey of Lucas County, Ohio, Soil Conservation Service in cooperation with Ohio Department of Natural Resources, Division of Lands and Soil, and Ohio Agricultural Research and Development Center, 1980: Sheet Number 29.
68. U.S. Environmental Protection Agency, Office of Air and Radiation, Volume 1: The K_{d} Model, Methods of Measurement, and Application of Chemical Reaction Codes, EPA 402-R-99-004A, 1999.
69. U.S. Environmental Protection Agency, The Brownfields and Land Revitalization Technology and Support Center, 1998. http://www.brownfieldstsc.org/glossary.cfm?lett=H
70. U.S. Environmental Protection Agency, 2000. http://oaspub.epa.gov/enviro/fii_master.fii_retrieve?county_name=lucas&state_code=OH& all_programs=YES&program_search=1&report=1&page_no=1&output_sql_switch=TRUE& database_type=CERCLIS
71. Vallino, M., Mass, N., Lumini, E., Bianciotto, V., Berta, G., Bonfante, P., “Assessment of arbusuclar mycorrhisal fungal diversity in roots of Solidago gigantean growing in a polluted soil in Northern Italy,” Environmental Microbiology, 2006. 8(6): p. 971-983.
72. Van Der Zee, S., Temminghoff, E., Marinussen, M., “Competition Effects for Copper Between Soil, Soil Solution, and Yeast in a Bioassay for Folsomia Candida Willem,” Environmental Toxicology and Chemistry, 2004. 23(7): p. 1743-1750.
73. Weber, J., Connection of Humic substances with mineral fraction. 2000. http://www.ar.wroc.pl/˜weber/kombi2.htm
74. Wilcke, W., “Small-Scale Variability of Metal Concentrations in Soil Leachates,” Soil Sci. Soc. Am. J., 2000. 64: p. 138-143.
75. Williams, C. H., “Soil acidification under clover pasture,” Aust. J. Exp. Agric. Husb., 1980. 20: p. 561-7.
76. Zhang, H., Penn, R. L., Hamers, R. J., Banfield, J. F., “Enhanced Adsorption of Molecules on Surfaces of Nanocrystalline Particles,” Journal of Physical Chemistry. B, 1999. 103: p. 4656-4662.
77. Zhang, M., He, Z., Calvert, D. V., Stofella, P. J., “Extractibility and Mobility of Copper and Zinc Accumulated in Sandy Soils,” Soil Science Society of China, 2006. 16(1): p. 43-49.

### Key to Tables A1 to A4

1. Column A: Sample Name
2. Column B: ICP Name
3. Column C: C_{0,ICP} (ppm); Initial copper concentration from ICP analysis
4. Column D: M₀ (mg); Initial copper mass calculated from C_{0,ICP}
5. Column E: V_{A} (ml); Aliquot Volume
6. Column F: DF; Dilution Factor
7. Column G: A (% by volume); Acid added to the ICP tube
8. Column H: C_{A,ICP} (ppm); Copper concentration in aliquot
9. Column I: C_{A,COR} (ppm); Corrected copper concentration of the aliquot
10. Column J: M_{A} (mg); Mass of copper in aliquot
11. Column K: M_{T} (mg); Total copper mass in 25 ml solution after 24 hours
12. Column L: M_{R} (mg); Copper mass remaining after removal of aliquot
13. Column M: M_{S} (mg); Copper mass adsorbed by soil
14. Column N: SM (g); Soil mass
15. Column O: M_{S,mg/kg}; Copper mass adsorbed to soil in units of mg/kg
16. Column P: Sample name
17. Column Q: Average M_{S} (mg); Average copper mass adsorbed by soil
18. Column R: K_{d} (l/kg); Partition coefficient
19. Column S: Average K_{d} (l/kg); Average partition coefficient
20. Column T: pH; pH value of copper solution after contact with soil
21. Column U: % Cu Mass Adsorbed

TABLE A1
Treasure Island Dump Adsorption Results

| A | B | C | D | E | F | G | H |
|---|---|---|---|---|---|---|---|
| Sample Name | ICP Name | C_{0, ICP} (ppm) | M₀ (mg) | V_{A} (ml) | DF | A (% by volume) | C_{A, ICP} (ppm) |
| treasure1-1PPM | 63 | 0.78 | 0.02 | 15 | 1 | 0.03 | −0.20 |
| treasure2-1PPM | 64 | 0.79 | 0.02 | 20 | 1 | 0.03 | −0.20 |
| treasure3-1PPM | 65 | 0.80 | 0.02 | 20 | 1 | 0.03 | −0.19 |
| treasure1-5PPM | 66 | 4.95 | 0.12 | 20 | 1 | 0.03 | −0.13 |
| treasure2-5PPM | 67 | 4.93 | 0.12 | 20 | 1 | 0.03 | −0.14 |
| treasure3-5PPM | 68 | 4.89 | 0.12 | 20 | 1 | 0.03 | −0.13 |
| treasure1-10PPM | 69 | 10.05 | 0.25 | 20 | 1 | 0.03 | −0.03 |
| treasure2-10PPM | 70 | 10.01 | 0.25 | 20 | 1 | 0.03 | 0.10 |
| treasure3-10PPM | 71 | 10.00 | 0.25 | 20 | 1 | 0.03 | 0.02 |
| treasure1-25PPM | 72 | 25.34 | 0.63 | 20 | 1 | 0.03 | 7.58 |
| treasure2-25PPM | 73 | 25.22 | 0.63 | 20 | 1 | 0.03 | 2.51 |
| treasure3-25PPM | 74 | 25.13 | 0.63 | 20 | 1 | 0.03 | 2.42 |
| treasure1-50PPM | 75 | 50.96 | 1.27 | 20 | 1 | 0.03 | 17.53 |
| treasure2-50PPM | 76 | 50.69 | 1.27 | 20 | 1 | 0.03 | 17.23 |
| treasure3-50PPM | 77 | 50.56 | 1.26 | 20 | 1 | 0.03 | 15.81 |
| treasure1-100PPM | 78 | 102.74 | 2.57 | 20 | 1 | 0.03 | 73.93 |
| treasure2-100PPM | 79 | 101.58 | 2.54 | 20 | 1 | 0.03 | 71.63 |
| treasure3-100PPM | 80 | 101.53 | 2.54 | 20 | 1 | 0.03 | 74.28 |
| treasure1-150PPM | 81 | 145.85 | 3.65 | 20 | 1 | 0.03 | 129.50 |
| treasure2-150PPM | 82 | 145.33 | 3.63 | 20 | 1 | 0.03 | 127.20 |
| treasure3-150PPM | 83 | 144.72 | 3.62 | 20 | 1 | 0.03 | 125.40 |
| treasure1-200PPM | 84 | 191.27 | 4.78 | 20 | 1 | 0.03 | 170.30 |
| treasure2-200PPM | 85 | 189.93 | 4.75 | 20 | 1 | 0.03 | 169.40 |
| treasure3-200PPM | 86 | 190.04 | 4.75 | 20 | 1 | 0.03 | 173.90 |

| A | I | J | K | L | M | N | O |
|---|---|---|---|---|---|---|---|
| Sample Name | C_{A, COR} (ppm) | M_{A} (mg) | M_{T} (mg) | M_{R} (mg) | M_{S} (mg) | SM (g) | M_{S}′ (mg/kg) |
| treasure1-1PPM | 0.00 | 0.00 | 0.00 | 0.00 | 0.02 | 1.0009 | 19.37 |
| treasure2-1PPM | 0.00 | 0.00 | 0.00 | 0.00 | 0.02 | 1.0029 | 19.60 |
| treasure3-1PPM | 0.00 | 0.00 | 0.00 | 0.00 | 0.02 | 1.0004 | 19.96 |
| treasure1-5PPM | 0.00 | 0.00 | 0.00 | 0.00 | 0.12 | 1.0054 | 123.01 |
| treasure2-5PPM | 0.00 | 0.00 | 0.00 | 0.00 | 0.12 | 1.0017 | 122.98 |
| treasure3-5PPM | 0.00 | 0.00 | 0.00 | 0.00 | 0.12 | 1.0018 | 122.09 |
| treasure1-10PPM | 0.00 | 0.00 | 0.00 | 0.00 | 0.25 | 1.0004 | 251.22 |
| treasure2-10PPM | 0.10 | 0.00 | 0.00 | 0.00 | 0.25 | 1.0003 | 247.76 |
| treasure3-10PPM | 0.02 | 0.00 | 0.00 | 0.00 | 0.25 | 1.0024 | 249.02 |
| treasure1-25PPM | 7.80 | 0.16 | 0.20 | 0.04 | 0.44 | 1.0013 | 437.77 |
| treasure2-25PPM | 2.58 | 0.05 | 0.06 | 0.01 | 0.57 | 1.0028 | 564.46 |
| treasure3-25PPM | 2.49 | 0.05 | 0.06 | 0.01 | 0.57 | 1.0008 | 565.58 |
| treasure1-50PPM | 18.06 | 0.36 | 0.45 | 0.09 | 0.82 | 1.0009 | 821.97 |
| treasure2-50PPM | 17.75 | 0.35 | 0.44 | 0.09 | 0.82 | 0.9994 | 823.98 |
| treasure3-50PPM | 16.28 | 0.33 | 0.41 | 0.08 | 0.86 | 0.9994 | 857.47 |
| treasure1-100PPM | 76.15 | 1.52 | 1.90 | 0.38 | 0.66 | 1.0019 | 663.60 |
| treasure2-100PPM | 73.78 | 1.48 | 1.84 | 0.37 | 0.69 | 1.0041 | 692.15 |
| treasure3-100PPM | 76.51 | 1.53 | 1.91 | 0.38 | 0.63 | 1.0017 | 624.41 |
| treasure1-150PPM | 133.39 | 2.67 | 3.33 | 0.67 | 0.31 | 1.0006 | 311.39 |
| treasure2-150PPM | 131.02 | 2.62 | 3.28 | 0.66 | 0.36 | 1.0005 | 357.75 |
| treasure3-150PPM | 129.16 | 2.58 | 3.23 | 0.65 | 0.39 | 1.0004 | 388.67 |
| treasure1-200PPM | 175.41 | 3.51 | 4.39 | 0.88 | 0.40 | 1.0031 | 395.32 |
| treasure2-200PPM | 174.48 | 3.49 | 4.36 | 0.87 | 0.39 | 1.0011 | 385.83 |
| treasure3-200PPM | 179.12 | 3.58 | 4.48 | 0.90 | 0.27 | 1.0012 | 272.62 |

| P | Q | R | S | T | U |
|---|---|---|---|---|---|
| Sample Name | Average M_{S} (mg) | K_{d} (l/kg) | Average K_{d} (l/kg) | pH | % Cu Mass Adsorbed |
| treasure1-1PPM | | 193671.70 | | | |
| treasure2-1PPM | | 196032.76 | | | |
| treasure3-1PPM | 0.02 | 199585.67 | 196430.04 | 7.5 | 100 |
| treasure1-5PPM | | 1230129.80 | | | |
| treasure2-5PPM | | 1229789.36 | | | |
| treasure3-5PPM | 0.12 | 1220927.33 | 1226948.83 | 6.6 | 100 |
| treasure1-10PPM | | 2512195.12 | | | |
| treasure2-10PPM | | 2469.64 | | | |
| treasure3-10PPM | 0.25 | 15110.61 | 843258.46 | 6.3 | 100 |
| treasure1-25PPM | | 56.09 | | | |
| treasure2-25PPM | | 218.51 | | | |
| treasure3-25PPM | 0.52 | 227.09 | 167.23 | 6 | 83 |
| treasure1-50PPM | | 45.52 | | | |
| treasure2-50PPM | | 46.43 | | | |
| treasure3-50PPM | 0.83 | 52.66 | 48.20 | 5.5 | 66 |
| treasure1-100PPM | | 8.71 | | | |
| treasure2-100PPM | | 9.38 | | | |
| treasure3-100PPM | 0.66 | 8.16 | 8.75 | 3.8 | 26 |
| treasure1-150PPM | | 2.33 | | | |
| treasure2-150PPM | | 2.73 | | | |
| treasure3-150PPM | 0.35 | 3.01 | 2.69 | 3.8 | 10 |
| treasure1-200PPM | | 2.25 | | | |
| treasure2-200PPM | | 2.21 | | | |
| treasure3-200PPM | 0.35 | 1.52 | 2.00 | 3.8 | 7 |

| Standard | Replicate 1 (ppm) | Replicate 2 (ppm) | Replicate 3 (ppm) |
|---|---|---|---|
| blank | 0.05 | −0.01 | −0.05 |
| std 1, 50 ppm | 52.18 | 51.63 | 52.14 |
| std 2, 100 ppm | 103.60 | 103.50 | 102.50 |
| std 3, 150 ppm | 153.30 | 152.40 | 151.40 |
| std 4, 200 ppm | 199.60 | 199.00 | 197.50 |
| std 5, 250 ppm | 244.70 | 243.50 | 242.90 |

Copper analyses for blanks and standards using Nanopure water.

TABLE A2
Bassett Street Warehouse Adsorption Results

| A | B | C | D | E | F | G | H |
|---|---|---|---|---|---|---|---|
| Sample Name | ICP Name | C_{0, ICP} (ppm) | M₀ (mg) | V_{A} (ml) | DF | A (% by volume) | C_{A, ICP} (ppm) |
| basett1-1PPM | 1 | 0.78 | 0.02 | 20 | 1 | 0.03 | −0.04 |
| basett2-1PPM | 2 | 0.79 | 0.02 | 20 | 1 | 0.03 | −0.06 |
| basett3-1PPM | 3 | 0.80 | 0.02 | 20 | 1 | 0.03 | −0.06 |
| bassett1-5PPM | 4 | 4.95 | 0.12 | 20 | 1 | 0.03 | −0.02 |
| bassett2-5PPM | 5 | 4.93 | 0.12 | 20 | 1 | 0.03 | −0.03 |
| bassett3-5PPM | 6 | 4.89 | 0.12 | 20 | 1 | 0.03 | −0.03 |
| bassett1-10PPM | 7 | 10.05 | 0.25 | 20 | 1 | 0.03 | 0.03 |
| bassett2-10PPM | 8 | 10.01 | 0.25 | 20 | 1 | 0.03 | 0.09 |
| bassett3-10PPM | 9 | 10.00 | 0.25 | 20 | 1 | 0.03 | 0.05 |
| bassett1-25PPM | 10 | 25.34 | 0.63 | 20 | 1 | 0.03 | 5.13 |
| bassett2-25PPM | 11 | 25.22 | 0.63 | 20 | 1 | 0.03 | 6.34 |
| bassett3-25PPM | 12 | 25.13 | 0.63 | 20 | 1 | 0.03 | 5.06 |
| bassett1-50PPM | 13 | 50.96 | 1.27 | 20 | 1 | 0.03 | 29.70 |
| bassett2-50PPM | 14 | 50.69 | 1.27 | 20 | 1 | 0.03 | 30.01 |
| bassett3-50PPM | 15 | 50.56 | 1.26 | 20 | 1 | 0.03 | 30.69 |
| bassett1-100PPM | 16 | 102.74 | 2.57 | 20 | 1 | 0.03 | 84.18 |
| bassett2-100PPM | 17 | 101.58 | 2.54 | 20 | 1 | 0.03 | 83.94 |
| bassett3-100PPM | 18 | 101.53 | 2.54 | 20 | 1 | 0.03 | 84.40 |
| bassett1-150PPM | 19 | 145.85 | 3.65 | 20 | 1 | 0.03 | 133.20 |
| bassett2-150PPM | 20 | 145.33 | 3.63 | 20 | 1 | 0.03 | 131.90 |
| bassett3-150PPM | 21 | 144.72 | 3.62 | 20 | 1 | 0.03 | 133.40 |
| bassett1-200PPM | 22 | 191.27 | 4.78 | 20 | 1 | 0.03 | 176.30 |
| bassett2-200PPM | 23 | 189.93 | 4.75 | 20 | 1 | 0.03 | 177.10 |
| bassett3-200PPM | 24 | 190.04 | 4.75 | 20 | 1 | 0.03 | 173.00 |

| A | I | J | K | L | M | N | O |
|---|---|---|---|---|---|---|---|
| Sample Name | C_{A, COR} (ppm) | M_{A} (mg) | M_{T} (mg) | M_{R} (mg) | M_{S} (mg) | SM (g) | M_{S}′ (mg/kg) |
| basett1-1PPM | 0.00 | 0.00 | 0.00 | 0.00 | 0.02 | 1.001 | 19.36 |
| basett2-1PPM | 0.00 | 0.00 | 0.00 | 0.00 | 0.02 | 1.002 | 19.61 |
| basett3-1PPM | 0.00 | 0.00 | 0.00 | 0.00 | 0.02 | 1.005 | 19.87 |
| bassett1-5PPM | 0.00 | 0.00 | 0.00 | 0.00 | 0.12 | 1.001 | 123.60 |
| bassett2-5PPM | 0.00 | 0.00 | 0.00 | 0.00 | 0.12 | 1.000 | 123.14 |
| bassett3-5PPM | 0.00 | 0.00 | 0.00 | 0.00 | 0.12 | 1.002 | 122.12 |
| bassett1-10PPM | 0.03 | 0.00 | 0.00 | 0.00 | 0.25 | 1.001 | 250.43 |
| bassett2-10PPM | 0.09 | 0.00 | 0.00 | 0.00 | 0.25 | 1.002 | 247.69 |
| bassett3-10PPM | 0.05 | 0.00 | 0.00 | 0.00 | 0.25 | 1.002 | 248.24 |
| bassett1-25PPM | 5.28 | 0.11 | 0.13 | 0.03 | 0.50 | 1.003 | 500.16 |
| bassett2-25PPM | 6.53 | 0.13 | 0.16 | 0.03 | 0.47 | 1.002 | 466.55 |
| bassett3-25PPM | 5.22 | 0.10 | 0.13 | 0.03 | 0.50 | 1.001 | 497.26 |
| bassett1-50PPM | 30.59 | 0.61 | 0.76 | 0.15 | 0.51 | 1.001 | 508.88 |
| bassett2-50PPM | 30.91 | 0.62 | 0.77 | 0.15 | 0.49 | 1.003 | 492.77 |
| bassett3-50PPM | 31.61 | 0.63 | 0.79 | 0.16 | 0.47 | 0.997 | 475.04 |
| bassett1-100PPM | 86.71 | 1.73 | 2.17 | 0.43 | 0.40 | 1.004 | 399.33 |
| bassett2-100PPM | 86.46 | 1.73 | 2.16 | 0.43 | 0.38 | 1.001 | 377.78 |
| bassett3-100PPM | 86.93 | 1.74 | 2.17 | 0.43 | 0.36 | 1.002 | 364.26 |
| bassett1-150PPM | 137.20 | 2.74 | 3.43 | 0.69 | 0.22 | 1.001 | 216.17 |
| bassett2-150PPM | 135.86 | 2.72 | 3.40 | 0.68 | 0.24 | 1.001 | 236.62 |
| bassett3-150PPM | 137.40 | 2.75 | 3.44 | 0.69 | 0.18 | 1.002 | 182.42 |
| bassett1-200PPM | 181.59 | 3.63 | 4.54 | 0.91 | 0.24 | 1.002 | 241.66 |
| bassett2-200PPM | 182.41 | 3.65 | 4.56 | 0.91 | 0.19 | 1.002 | 187.56 |
| bassett3-200PPM | 178.19 | 3.56 | 4.45 | 0.89 | 0.30 | 1.000 | 296.10 |

| P | Q | R | S | T | U |
|---|---|---|---|---|---|
| Sample Name | Average M_{S} (mg) | K_{d} (l/kg) | Average K_{d} (l/kg) | pH | % Cu Mass Adsorbed |
| basett1-1PPM | | 193613.66 | | | |
| basett2-1PPM | | 196130.54 | | | |
| basett3-1PPM | 0.02 | 198672.14 | 196138.78 | 6.3 | 100 |
| bassett1-5PPM | | 1236030.88 | | | |
| bassett2-5PPM | | 1231387.45 | | | |
| bassett3-5PPM | 0.12 | 1221171.13 | 1229529.82 | 6.3 | 100 |
| bassett1-10PPM | | 8745.86 | | | |
| bassett2-10PPM | | 2809.31 | | | |
| bassett3-10PPM | 0.25 | 5182.99 | 5579.39 | 6.3 | 100 |
| bassett1-25PPM | | 94.73 | | | |
| bassett2-25PPM | | 71.48 | | | |
| bassett3-25PPM | 0.49 | 95.33 | 87.18 | 6 | 78 |
| bassett1-50PPM | | 16.63 | | | |
| bassett2-50PPM | | 15.94 | | | |
| bassett3-50PPM | 0.49 | 15.03 | 15.87 | 5.5 | 39 |
| bassett1-100PPM | | 4.61 | | | |
| bassett2-100PPM | | 4.37 | | | |
| bassett3-100PPM | 0.38 | 4.19 | 4.39 | 3.8 | 15 |
| bassett1-150PPM | | 1.58 | | | |
| bassett2-150PPM | | 1.74 | | | |
| bassett3-150PPM | 0.21 | 1.33 | 1.55 | 3.8 | 6 |
| bassett1-200PPM | | 1.33 | | | |
| bassett2-200PPM | | 1.03 | | | |
| bassett3-200PPM | 0.24 | 1.66 | 1.34 | 3.8 | 5 |

| Standard | Replicate 1 (ppm) | Replicate 2 (ppm) | Replicate 3 (ppm) |
|---|---|---|---|
| blank | −0.05 | 0.00 | 0.04 |
| std 1, 50 ppm | 52.11 | 52.24 | 52.19 |
| std 2, 100 ppm | 103.20 | 102.40 | 102.60 |
| std 3, 150 ppm | 152.10 | 151.70 | 151.70 |
| std 4, 200 ppm | 199.10 | 199.10 | 201.10 |
| std 5, 250 ppm | 243.30 | 243.60 | 243.50 |

Copper analyses for blanks and standards using Nanopure water.

TABLE A3
Tiffin Landfill Adsorption Results

| A | B | C | D | E | F | G | H |
|---|---|---|---|---|---|---|---|
| Sample Name | ICP Name | C_{0, ICP} (ppm) | M₀ (mg) | V_{A} (ml) | DF | A (% by volume) | C_{A, ICP} (ppm) |
| tiffin1-1PPM | 1 | 1.09 | 0.03 | 20 | 0.2 | 0.03 | −0.09 |
| tiffin2-1PPM | 2 | 1.10 | 0.03 | 10 | 0.2 | 0.03 | −0.08 |
| tiffin3-1PPM | 3 | 1.09 | 0.03 | 10 | 0.2 | 0.03 | −0.09 |
| tiffin1-5PPM | 4 | 5.42 | 0.14 | 10 | 0.2 | 0.03 | −0.08 |
| tiffin2-5PPM | 5 | 5.44 | 0.14 | 10 | 0.2 | 0.03 | −0.08 |
| tiffin3-5PPM | 6 | 5.47 | 0.14 | 10 | 0.2 | 0.03 | −0.08 |
| tiffin1-10PPM | 7 | 10.57 | 0.26 | 10 | 0.2 | 0.03 | 0.04 |
| tiffin2-10PPM | 8 | 10.53 | 0.26 | 10 | 0.2 | 0.03 | 0.00 |
| tiffin3-10PPM | 9 | 10.60 | 0.26 | 10 | 0.2 | 0.03 | 0.03 |
| tiffin1-25PPM | 10 | 26.62 | 0.67 | 10 | 0.2 | 0.03 | 2.88 |
| tiffin2-25PPM | 11 | 26.74 | 0.67 | 10 | 0.2 | 0.03 | 2.83 |
| tiffin3-25PPM | 12 | 26.73 | 0.67 | 10 | 0.2 | 0.03 | 2.88 |
| tiffin1-50PPM | 13 | 54.60 | 1.37 | 10 | 0.2 | 0.03 | 9.36 |
| tiffin2-50PPM | 14 | 54.44 | 1.36 | 10 | 0.2 | 0.03 | 9.39 |
| tiffin3-50PPM | 15 | 54.69 | 1.37 | 10 | 0.2 | 0.03 | 9.29 |
| tiffin1-100PPM | 16 | 102.52 | 2.56 | 10 | 0.2 | 0.03 | 19.92 |
| tiffin2-100PPM | 17 | 102.62 | 2.57 | 10 | 0.2 | 0.03 | 21.06 |
| tiffin3-100PPM | 18 | 102.69 | 2.57 | 10 | 0.2 | 0.03 | 20.41 |
| tiffin1-150PPM | 19 | 146.16 | 3.65 | 10 | 0.2 | 0.03 | 29.72 |
| tiffin2-150PPM | 20 | 146.67 | 3.67 | 10 | 0.2 | 0.03 | 32.00 |
| tiffin3-150PPM | 21 | 147.39 | 3.68 | 10 | 0.2 | 0.03 | 29.78 |
| tiffin1-200PPM | 22 | 192.40 | 4.81 | 10 | 0.2 | 0.03 | 40.01 |
| tiffin2-200PPM | 23 | 194.16 | 4.85 | 10 | 0.2 | 0.03 | 42.14 |
| tiffin3-200PPM | 24 | 194.77 | 4.87 | 10 | 0.2 | 0.03 | 61.28 |

| A | I | J | K | L | M | N | O |
|---|---|---|---|---|---|---|---|
| Sample Name | C_{A, COR} (ppm) | M_{A} (mg) | M_{T} (mg) | M_{R} (mg) | M_{S} (mg) | SM (g) | MS′ (mg/kg) |
| tiffin1-1PPM | 0.00 | 0.00 | 0.00 | 0.00 | 0.03 | 1.006 | 26.38 |
| tiffin2-1PPM | 0.00 | 0.00 | 0.00 | 0.00 | 0.03 | 1.000 | 26.55 |
| tiffin3-1PPM | 0.00 | 0.00 | 0.00 | 0.00 | 0.03 | 1.003 | 26.48 |
| tiffin1-5PPM | 0.00 | 0.00 | 0.00 | 0.00 | 0.13 | 1.002 | 131.88 |
| tiffin2-5PPM | 0.00 | 0.00 | 0.00 | 0.00 | 0.13 | 1.001 | 131.92 |
| tiffin3-5PPM | 0.00 | 0.00 | 0.00 | 0.00 | 0.13 | 1.003 | 131.64 |
| tiffin1-10PPM | 0.18 | 0.00 | 0.00 | 0.00 | 0.26 | 1.003 | 258.89 |
| tiffin2-10PPM | 0.00 | 0.00 | 0.00 | 0.00 | 0.26 | 1.000 | 263.17 |
| tiffin3-10PPM | 0.15 | 0.00 | 0.00 | 0.00 | 0.26 | 1.004 | 260.21 |
| tiffin1-25PPM | 14.47 | 0.14 | 0.36 | 0.22 | 0.30 | 1.002 | 303.05 |
| tiffin2-25PPM | 14.24 | 0.14 | 0.36 | 0.21 | 0.31 | 1.002 | 311.82 |
| tiffin3-25PPM | 14.48 | 0.14 | 0.36 | 0.22 | 0.31 | 1.003 | 305.26 |
| tiffin1-50PPM | 47.10 | 0.47 | 1.18 | 0.71 | 0.19 | 1.001 | 187.37 |
| tiffin2-50PPM | 47.21 | 0.47 | 1.18 | 0.71 | 0.18 | 1.002 | 180.45 |
| tiffin3-50PPM | 46.71 | 0.47 | 1.17 | 0.70 | 0.20 | 1.001 | 199.29 |
| tiffin1-100PPM | 100.20 | 1.00 | 2.50 | 1.50 | 0.06 | 1.004 | 57.76 |
| tiffin2-100PPM | 105.93 | 1.06 | 2.65 | 1.59 | −0.08 | 1.005 | −82.39 |
| tiffin3-100PPM | 102.66 | 1.03 | 2.57 | 1.54 | 0.00 | 1.000 | 0.72 |
| tiffin1-150PPM | 149.49 | 1.49 | 3.74 | 2.24 | −0.08 | 1.004 | −83.04 |
| tiffin2-150PPM | 160.96 | 1.61 | 4.02 | 2.41 | −0.36 | 1.005 | −355.60 |
| tiffin3-150PPM | 149.79 | 1.50 | 3.74 | 2.25 | −0.06 | 1.000 | −60.04 |
| tiffin1-200PPM | 201.25 | 2.01 | 5.03 | 3.02 | −0.22 | 1.001 | −220.91 |
| tiffin2-200PPM | 211.96 | 2.12 | 5.30 | 3.18 | −0.45 | 1.001 | −445.01 |
| tiffin3-200PPM | 308.24 | 3.08 | 7.71 | 4.62 | −2.84 | 1.001 | −2832.67 |

| P | Q | R | S | T | U |
|---|---|---|---|---|---|
| Sample Name | Average Mₛ (mg) | K_{d} (l/kg) | Average K_{d} (l/kg) | pH | % Cu Mass Adsorbed |
| tiffin1-1PPM | | 269961.74 | | | |
| tiffin2-1PPM | | 275497.45 | | | |
| tiffin3-1PPM | 0.03 | 272526.18 | 272661.79 | 6.9 | 100 |
| tiffin1-5PPM | | 1352164.25 | | | |
| tiffin2-5PPM | | 1358484.82 | | | |
| tiffin3-5PPM | 0.13 | 1362057.71 | 1357568.93 | 6.9 | 100 |
| tiffin1-10PPM | | 2588891.16 | | | |
| tiffin2-10PPM | | 2631650.00 | | | |
| tiffin3-10PPM | 0.26 | 2602079.51 | 2607540.22 | 6.6 | 99 |
| tiffin1-25PPM | | 20.94 | | | |
| tiffin2-25PPM | | 21.90 | | | |
| tiffin3-25PPM | 0.31 | 21.08 | 21.31 | 4.4 | 46 |
| tiffin1-50PPM | | 3.98 | | | |
| tiffin2-50PPM | | 3.82 | | | |
| tiffin3-50PPM | 0.19 | 4.27 | 4.02 | 3.8 | 14 |
| tiffin1-100PPM | | 0.58 | | | |
| tiffin2-100PPM | | −0.78 | | | |
| tiffin3-100PPM | −0.01 | 0.01 | −0.06 | 3.8 | 0 |
| tiffin1-150PPM | | −0.56 | | | |
| tiffin2-150PPM | | −2.21 | | | |
| tiffin3-150PPM | −0.17 | −0.40 | −1.06 | 3.8 | −5 |
| tiffin1-200PPM | | −1.10 | | | |
| tiffin2-200PPM | | −2.10 | | | |
| tiffin3-200PPM | −1.17 | −9.19 | −4.13 | 3.8 | −24 |

| Standard | Replicate 1 (ppm) | Replicate 2 (ppm) | Replicate 3 (ppm) |
|---|---|---|---|
| blank | −0.04 | 0.02 | 0.01 |
| std 1, 50 ppm | 52.55 | 52.41 | 51.99 |
| std 2, 100 ppm | 105.20 | 104.70 | 105.00 |
| std 3, 150 ppm | 150.10 | 149.50 | 150.00 |
| std 4, 200 ppm | 198.30 | 198.60 | 198.40 |
| std 5, 250 ppm | 244.20 | 245.30 | 243.70 |

Copper analyses for blanks and standards using Nanopure water.

TABLE A4
Emmajean Adsorption Results

| A | B | C | D | E | F | G | H |
|---|---|---|---|---|---|---|---|
| Sample Name | ICP Name | C_{0, ICP} (ppm) | M₀ (mg) | V_{A} (ml) | DF | A (% by volume) | C_{A, ICP} (ppm) |
| emmajean1-1PPM | 15 | 0.78 | 0.02 | 15 | 1 | 0.03 | −0.14 |
| emmajean2-1PPM | 16 | 0.79 | 0.02 | 15 | 1 | 0.03 | −0.15 |
| emmajean3-1PPM | 17 | 0.80 | 0.02 | 15 | 1 | 0.03 | −0.15 |
| emmajean1-5PPM | 18 | 4.95 | 0.12 | 15 | 1 | 0.03 | 1.47 |
| emmajean2-5PPM | 19 | 4.93 | 0.12 | 15 | 1 | 0.03 | 1.19 |
| emmajean3-5PPM | 20 | 4.89 | 0.12 | 15 | 1 | 0.03 | 1.32 |
| emmajean1-10PPM | 21 | 10.05 | 0.25 | 15 | 1 | 0.03 | 5.50 |
| emmajean2-10PPM | 22 | 10.01 | 0.25 | 15 | 1 | 0.03 | 5.82 |
| emmajean3-10PPM | 23 | 10.00 | 0.25 | 15 | 1 | 0.03 | 5.64 |
| emmaiean1-25PPM | 24 | 25.34 | 0.63 | 15 | 1 | 0.03 | 19.24 |
| emmajean2-25PPM | 25 | 25.22 | 0.63 | 15 | 1 | 0.03 | 20.02 |
| emmajean3-25PPM | 26 | 25.13 | 0.63 | 15 | 1 | 0.03 | 20.18 |
| emmajean1-50PPM | 27 | 50.96 | 1.27 | 15 | 1 | 0.03 | 44.24 |
| emmajean2-50PPM | 28 | 50.69 | 1.27 | 15 | 1 | 0.03 | 44.69 |
| emmajean3-50PPM | 29 | 50.56 | 1.26 | 15 | 1 | 0.03 | 44.74 |
| emmajean1-100PPM | 30 | 102.74 | 2.57 | 15 | 1 | 0.03 | 95.07 |
| emmajean2-100PPM | 31 | 101.58 | 2.54 | 15 | 1 | 0.03 | 91.64 |
| emmajean3-100PPM | 32 | 101.53 | 2.54 | 15 | 1 | 0.03 | 92.21 |
| emmajean1-150PPM | 33 | 145.85 | 3.65 | 15 | 1 | 0.03 | 139.00 |
| emmajean2-150PPM | 34 | 145.33 | 3.63 | 15 | 1 | 0.03 | 141.20 |
| emmajean3-150PPM | 35 | 144.72 | 3.62 | 15 | 1 | 0.03 | 141.70 |
| emmajean1-200PPM | 36 | 191.27 | 4.78 | 15 | 1 | 0.03 | 186.70 |
| emmajean2-200PPM | 37 | 189.93 | 4.75 | 15 | 1 | 0.03 | 181.60 |
| emmajean3-200PPM | 38 | 190.04 | 4.75 | 15 | 1 | 0.03 | 185.40 |

| A | I | J | K | L | M | N | O |
|---|---|---|---|---|---|---|---|
| Sample Name | C_{A, COR} (ppm) | M_{A} (mg) | M_{T} (mg) | M_{R} (mg) | M_{S} (mg) | SM (g) | M_{S}′ (mg/kg) |
| emmajean1-1PPM | 0.00 | 0.00 | 0.00 | 0.00 | 0.02 | 1.000 | 19.38 |
| emmajean2-1PPM | 0.00 | 0.00 | 0.00 | 0.00 | 0.02 | 0.996 | 19.74 |
| emmajean3-1PPM | 0.00 | 0.00 | 0.00 | 0.00 | 0.02 | 1.001 | 19.94 |
| emmajean1-5PPM | 1.52 | 0.02 | 0.04 | 0.02 | 0.09 | 1.001 | 85.64 |
| emmajean2-5PPM | 1.22 | 0.02 | 0.03 | 0.01 | 0.09 | 0.994 | 93.10 |
| emmajean3-5PPM | 1.36 | 0.02 | 0.03 | 0.01 | 0.09 | 0.999 | 88.35 |
| emmajean1-10PPM | 5.67 | 0.09 | 0.14 | 0.06 | 0.11 | 0.995 | 110.14 |
| emmajean2-10PPM | 5.99 | 0.09 | 0.15 | 0.06 | 0.10 | 0.998 | 100.73 |
| emmajean3-10PPM | 5.81 | 0.09 | 0.15 | 0.06 | 0.10 | 1.003 | 104.43 |
| emmaiean1-25PPM | 19.82 | 0.30 | 0.50 | 0.20 | 0.14 | 0.996 | 138.55 |
| emmajean2-25PPM | 20.62 | 0.31 | 0.52 | 0.21 | 0.12 | 1.000 | 115.16 |
| emmajean3-25PPM | 20.79 | 0.31 | 0.52 | 0.21 | 0.11 | 0.999 | 108.74 |
| emmajean1-50PPM | 45.57 | 0.68 | 1.14 | 0.46 | 0.13 | 1.004 | 134.37 |
| emmajean2-50PPM | 46.03 | 0.69 | 1.15 | 0.46 | 0.12 | 0.999 | 116.46 |
| emmajean3-50PPM | 46.08 | 0.69 | 1.15 | 0.46 | 0.11 | 0.998 | 112.27 |
| emmajean1-100PPM | 97.92 | 1.47 | 2.45 | 0.98 | 0.12 | 1.002 | 120.23 |
| emmajean2-100PPM | 94.39 | 1.42 | 2.36 | 0.94 | 0.18 | 0.999 | 179.91 |
| emmajean3-100PPM | 94.98 | 1.42 | 2.37 | 0.95 | 0.16 | 1.000 | 163.75 |
| emmajean1-150PPM | 143.17 | 2.15 | 3.58 | 1.43 | 0.07 | 0.997 | 67.17 |
| emmajean2-150PPM | 145.44 | 2.18 | 3.64 | 1.45 | 0.00 | 0.996 | −2.58 |
| emmajean3-150PPM | 145.95 | 2.19 | 3.65 | 1.46 | −0.03 | 0.994 | −31.09 |
| emmajean1-200PPM | 192.30 | 2.88 | 4.81 | 1.92 | −0.03 | 0.994 | −25.90 |
| emmajean2-200PPM | 187.05 | 2.81 | 4.68 | 1.87 | 0.07 | 1.000 | 72.07 |
| emmajean3-200PPM | 190.96 | 2.86 | 4.77 | 1.91 | −0.02 | 1.003 | −23.10 |

| P | Q | R | S | T | U |
|---|---|---|---|---|---|
| Sample Name | Average M_{S} (mg) | K_{d} (l/kg) | Average K_{d} (l/kg) | pH | % Cu Mass Adsorbed |
| emmajean1-1PPM | | 193826.62 | | | |
| emmajean2-1PPM | | 197371.00 | | | |
| emmajean3-1PPM | 0.02 | 199426.19 | 196874.60 | 6.3 | 100 |
| emmajean1-5PPM | | 56.44 | | | |
| emmajean2-5PPM | | 76.02 | | | |
| emmajean3-5PPM | 0.09 | 64.79 | 65.75 | 6.3 | 73 |
| emmajean1-10PPM | | 19.43 | | | |
| emmajean2-10PPM | | 16.81 | | | |
| emmajean3-10PPM | 0.10 | 17.97 | 18.07 | 4.6 | 42 |
| emmajean1-25PPM | | 6.99 | | | |
| emmajean2-25PPM | | 5.58 | | | |
| emmajean3-25PPM | 0.12 | 5.23 | 5.94 | 4.6 | 19 |
| emmajean1-50PPM | | 2.95 | | | |
| emmajean2-50PPM | | 2.53 | | | |
| emmajean3-50PPM | 0.12 | 2.44 | 2.64 | 3.8 | 10 |
| emmajean1-100PPM | | 1.23 | | | |
| emmajean2-100PPM | | 1.91 | | | |
| emmajean3-100PPM | 0.15 | 1.72 | 1.62 | 3.8 | 6 |
| emmajean1-150PPM | | 0.47 | | | |
| emmajean2-150PPM | | −0.02 | | | |
| emmajean3-150PPM | 0.01 | −0.21 | 0.08 | 3.8 | 0 |
| emmajean1-200PPM | | −0.13 | | | |
| emmajean2-200PPM | | 0.39 | | | |
| emmajean3-200PPM | 0.01 | −0.12 | 0.04 | 3.8 | 0 |

| Standard | Replicate 1 (ppm) | Replicate 2 (ppm) | Replicate 3 (ppm) |
|---|---|---|---|
| blank | 0.05 | −0.01 | −0.05 |
| std 1, 150 ppm | 52.18 | 51.63 | 52.14 |
| std 2, 100 ppm | 103.60 | 103.50 | 102.50 |
| std 3, 150 ppm | 153.30 | 152.40 | 151.40 |
| std 4, 200 ppm | 199.60 | 199.00 | 197.50 |
| std 5, 250 ppm | 244.70 | 243.50 | 242.90 |

Copper analyses for blanks and standards using Nanopure water.

What is claimed is:

1. A method to optimize soil conditions to increase the plant uptake rate of contaminants consisting essentially of comprehensive data evaluation to understand the mechanisms that control adsorption and plant growth, the data gained from a series of soil and plant analyses comprising: a) historical land use information, b) evaluating soils for contaminant identity and concentrations, c) evaluating on-site plants for contaminant identity and concentrations, d) particle size analysis of soil samples, e) total organic matter of soil samples, f) conducting batch adsorption experiments to determine Kd values at varying pH levels and varying concentrations of standard solutions, g) conducting on-site pH testing of soils, h) testing pH levels of standard solutions prior to and after contact with soils used for batch adsorption experiments, i) conducting alkalinity/hardness tests.

2. The method according to claim 1, wherein the historical land use information includes chemical use; chemical spills; type of traffic (i.e. semi truck vs small car); how many and type of businesses were on property; duration of land use; environmental assessments; identify contaminants with mobility dependent on pH, alkalinity/hardness reactions; organize data to discern extent of impacts on the land.

3. The method according to claim 1, wherein the contaminants in the soils and plants are selected from the group consisting of heavy metals that may be mobilized into a solution.

4. The method according to claim 3, wherein identified contaminants are analyzed for concentrations within the soil samples and composite (leaves, stems and roots) plant samples.

5. The method according to claim 4, wherein the concentration of contaminant in each plant specie is divided by the concentration of contaminant in its respective soil to calculate the bioconcentration factor (BCF).

6. The method according to claim 4, wherein a comparative analysis is conducted on all concentrations of contaminant found in each plant specie and listed to discern which plants have the greatest uptake rate in present soil conditions.

7. The method according to claim 1, wherein the particle size analysis can identify the clay, silt and sand fractions of the individual soil samples.

8. The method according to claim 1, wherein the total organic mater analysis can identify the organic matter fraction of the individual soil samples.

9. The method of claim 1, wherein the various standard solutions are tested for pH levels prior to contact with the soils for the batch adsorption experiments.

10. The method according to claim 1, wherein the batch adsorption experiments are conducted to find mass adsorbed comprising the following mathematical steps, which correspond to Figures A1 to A4:
STEP 1: Find the mass of copper in the original solution (M₀ in mg).
$${M}_{0} = {C}_{0 , ICP} \times {V}_{0} \times ( \frac{0.001 l}{1 ml} ) \times ( \frac{\frac{1 mg}{l}}{1 ppm} )$$
Where: C_{0,ICP} is the copper concentration (in ppm) measured by ICP in the original solution (Column C; note that 1 ppm=1 mg/l)
V₀ is volume of the original solution, which is 25±0.02 ml (note that 1 ml=0.001 l). For the calculations, 0.025 l was used.
STEP 2: Apply the corrections for acid content and, where necessary, dilution factor to the copper concentration measured by ICP in the aliquot (C_{A,COR} in ppm).
$${C}_{A , COR} = ( \frac{1}{DF} ) \times {C}_{A , ICP} + ( {C}_{A , ICP} \times A )$$
Where: C_{A,ICP} is the copper concentration (in ppm) measured in the aliquot by ICP (Column H).
DF is the dilution factor (dimensionless), which is always 0.2
A is the percent by volume of acid, which is always 0.03
Note that if there was no dilution of the original solution, the first term in the above equation drops out.
STEP 3: Find the mass of copper in the aliquot (M_{A} in mg)
$${M}_{A} = {C}_{A , COR} \times {V}_{A} \times ( \frac{0.001 l}{1 ml} ) \times ( \frac{\frac{1 mg}{l}}{1 ppm} )$$
Where: C_{A,COR} is from Step 2 (note that 1 ppm=1 mg/l)
V_{A} is the aliquot volume (in ml, Column E; note that 1 ml=0.001 l)
STEP 4: Calculate the mass of copper in the original 25 ml solution after 24 hours (M_{T} in mg) based on M_{A} from Step 3 and assuming that the copper ions were uniformly distributed throughout the original solution.
$${M}_{T} = ( \frac{{V}_{0}}{{V}_{A}} ) \times {M}_{A}$$
Where: V₀ is from Step 1
M_{A} and V_{A} are from Step 3
STEP 5: Find the mass of copper remaining in the original solution after removal of the aliquot (M_{R} in mg)
M_{R}=M_{T}−M_{A}
Where: M_{A} is from Step 3
M_{T} is from Step 4
STEP 6: Find the mass of copper adsorbed by the soil sample (M_{S} in mg)
M_{S}=M₀−M_{A}−M_{R}
Where: M₀ is from Step 1
M_{A} is from Step 3
M_{R} is from Step 5
Note that when using contaminated soils, negative values will occur when the contaminant is desorbing from the soil particle and going into solution. Such soils are ideal candidates for phytoremediation.
STEP 7: Find the mass of copper adsorbed by the soil sample in units of mg/kg (M_{S,mg/kg})
$${M}_{S , mg / kg} = ( \frac{{M}_{S}}{SM} ) \times ( \frac{1000 g}{1 kg} )$$
Where: MS is from Step 6
SM is the mass of soil (g) originally placed in the centrifuge tube.

11. The method according to claim 10, wherein the calculated mass adsorbed is used to calculate the Kd value of the soil samples using an empirical model comprising the following steps:
The empirical model to calculate Kd:
$${K}_{d} = \frac{{M}_{S , mg / kg}}{{C}_{A , COR}}$$
Where: K_{d}=partition coefficient (l/kg)
M_{S,mg/kg}=copper mass adsorbed on the substrate (mg/kg), from Step 7 in Section 2.5
C_{A,COR}=copper mass not adsorbed in aqueous solution (mg/l), from Step 2 in Section 2.5

12. The method of claim 1, wherein the on-site soils are tested for pH levels.

13. The method of claim 1, wherein the copper solutions for the batch adsorption experiments are tested for pH after 24 hour contact with the soils.

14. The method of claim 1, wherein the soils are tested for alkalinity and hardness.

15. The method of claim 13, wherein the alkalinity and hardness results are used to calculate a ratio by dividing the hardness by the alkalinity.

16. The method of claim 1, wherein a comprehensive data analysis of the test results can determine which soil mechanisms control adsorption and plant growth.

17. The method of claim 16, wherein a series of potted plant experiments can be designed around the soil mechanisms that control adsorption and plant growth in order to find the optimal soil conditions that will increase mobility of the targeted heavy metal to increase the uptake rate of the plants and to improve growing conditions for the plants.
